(19) United States
(12) Patent Application Publication
(10) Pub. No.: US 2026/0278017 A1
(43) Pub. Date: Sep. 17, 2026

(54) INFORMATION SEARCH METHOD

(71) Applicant: Tencent Technology (Shenzhen) Company Limited, Shenzhen (CN)

(72) Inventors: Sijia PING, Shenzhen (CN); Ziwen XU, Shenzhen (CN); Jinyang WANG, Shenzhen (CN)

(73) Assignee: Tencent Technology (Shenzhen) Company Limited, Shenzhen (CN)

(21) Appl. No.: 19/564,091

(22) Filed: Mar. 11, 2026

Related U.S. Application Data
(63) Continuation of application No. PCT/CN2024/124606, filed on Oct. 14, 2024.

(30) Foreign Application Priority Data
Dec. 26, 2023 (CN) 202311816348.3

(51) Int. Cl. G06F 16/9535; G06F 16/9537; G06F 16/9538; G06F 16/954

(52) U.S. Cl. CPC G06F 16/9535; G06F 16/9537; G06F 16/9538; G06F 16/954

(57) ABSTRACT

In an information search method, first search suggestion information is displayed in an information search interface on a display of a processing device when received target search information is related to one or more historical search operations. In the method, a current search result is generated based on the target search information and contextual corpus information that includes historical search information of the one or more historical search operations, browsed content from each historical search result of the one or more historical search operations, or records of feedback behaviors performed in association with the browsed content. In the method, the current search result is displayed in a search result interface on the display.

### RELATED APPLICATIONS

The present application is a continuation of International Application No. PCT/CN2024/124606, filed on Oct. 14, 2024, which claims priority to Chinese Patent Application No. 202311816348.3, entitled “INFORMATION SEARCH METHOD AND APPARATUS, ELECTRONIC DEVICE, AND STORAGE MEDIUM” and filed on Dec. 26, 2023. The entire disclosures of the prior applications are hereby incorporated by reference.

### FIELD OF THE TECHNOLOGY

This disclosure relates to the technical field of information search and retrieval, including an information search method and apparatus, an electronic device, a storage medium, and a program product.

### BACKGROUND OF THE DISCLOSURE

With the popularization of computers and the development of the Internet, people's use of networks has become increasingly frequent. Computers and networks have gradually become indispensable tools in people's daily lives. Network search services are widely applied to people's daily lives because they can provide various information and data for objects (e.g., users of the data search services), bringing great convenience to people.

In some network searches, when an object (e.g., a user) engages in solving a complex search problem, for example, creating a travel guide, the object may decompose the complex search problem into a plurality of search words or phrases. For each search word or phrase, the object may separately perform a network search using a search engine or a content platform. After performing a plurality of searches and browsing related content, the object organizes and collates information collected after each search to finally formulate a travel itinerary guide meeting the requirements of the object.

In summary, for some complex search problems, the object would likely perform a plurality of cross-platform searches and independently summarize the search results. Thus, the entire search process could be cumbersome, resulting in low search efficiency.

### SUMMARY

Embodiments of this disclosure provide an information search method and apparatus, an electronic device, a storage medium, and a program product, to improve information search efficiency of an object.

According to one aspect, one or more embodiments of this disclosure provide an information search method. In the method target search information of a current search operation is received by processing circuitry of a processing device. In the method, first search suggestion information is displayed in an information search interface on a display of the processing device when the target search information is related to one or more historical search operations, the first search suggestion information indicating summary information of a current search result based on the target search information and the one or more historical search operations. In the method, the current search result is obtained, by the processing circuitry of the processing device, based on a user operation on the first search suggestion information displayed in the information search interface. The current search result is generated based on the target search information and contextual corpus information that includes historical search information of the one or more historical search operations, browsed content from each historical search result of the one or more historical search operations, or records of feedback behaviors performed in association with the browsed content. In the method, the current search result is displayed in a search result interface on the display.

According to one aspect, one or more embodiments of this disclosure provide an information search method. In the method, contextual corpus information that includes historical search information of one or more historical search operations, browsed content from each historical search result of the one or more historical search operations, or records of feedback behaviors performed in association with the browsed content. In the method, target search information of a current search operation is received. In the method, the target search information and the contextual corpus information are inputted, by processing circuitry of a processing device, into a target language model based on a current search request when the target search information is related to one or more historical search operations. In the method, a current search result and summary information of the current search result are generated through the target language model. In the method, the summary information and the current search result are outputted, by the processing circuitry of the processing device, to a terminal for display, the terminal being configured to display first search suggestion information indicating the summary information in an information search interface, and to display a search result interface including the current search result.

According to one aspect, one or more embodiments of this disclosure provide an information search apparatus that includes processing circuitry. The processing circuitry is configured to receive target search information of a current search operation. The processing circuitry is configured to display first search suggestion information in an information search interface on a display of the apparatus when the target search information is related to one or more historical search operations, the first search suggestion information indicating summary information of a current search result based on the target search information and the one or more historical search operations. The processing circuitry is configured to obtain the current search result based on a user operation on the first search suggestion information displayed in the information search interface, the current search result being generated based on the target search information and contextual corpus information that includes historical search information of the one or more historical search operations, browsed content from each historical search result of the one or more historical search operations, or records of feedback behaviors performed in association with the browsed content. The processing circuitry is configured to display the current search result in a search result interface on the display.

According to one aspect, one or more embodiments of this disclosure provide an information search apparatus that includes processing circuitry. The processing circuitry is configured to obtain contextual corpus information that includes historical search information of one or more historical search operations, browsed content from each historical search result of the one or more historical search operations, or records of feedback behaviors performed in association with the browsed content. The processing circuitry is configured to receive target search information of a current search operation. The processing circuitry is configured to input the target search information and the contextual corpus information into a target language model based on a current search request when the target search information is related to one or more historical search operations. The processing circuitry is configured to generate a current search result and summary information of the current search result through the target language model. The processing circuitry is configured to output the summary information and the current search result to a terminal for display, the terminal being configured to display first search suggestion information indicating the summary information in an information search interface, and to display a search result interface including the current search result.

According to one aspect, one or more embodiments of this disclosure provide a non-transitory computer-readable storage medium storing instructions, which when executed by a processor, cause the processor to perform an information search method. In the method target search information of a current search operation is received by processing circuitry of a processing device. In the method, first search suggestion information is displayed in an information search interface on a display of the processing device when the target search information is related to one or more historical search operations, the first search suggestion information indicating summary information of a current search result based on the target search information and the one or more historical search operations. In the method, the current search result is obtained, by the processing circuitry of the processing device, based on a user operation on the first search suggestion information displayed in the information search interface. The current search result is generated based on the target search information and contextual corpus information that includes historical search information of the one or more historical search operations, browsed content from each historical search result of the one or more historical search operations, or records of feedback behaviors performed in association with the browsed content. In the method, the current search result is displayed in a search result interface on the display.

According to one aspect, one or more embodiments of this disclosure provide a non-transitory computer-readable storage medium storing instructions, which when executed by a processor, cause the processor to perform an information search method. In the method, contextual corpus information is obtained that includes historical search information of one or more historical search operations, browsed content from each historical search result of the one or more historical search operations, or records of feedback behaviors performed in association with the browsed content. In the method, target search information of a current search operation is received. In the method, the target search information and the contextual corpus information are inputted, by processing circuitry of a processing device, into a target language model based on a current search request when the target search information is related to one or more historical search operations. In the method, a current search result and summary information of the current search result are generated through the target language model. In the method, the summary information and the current search result are outputted, by the processing circuitry of the processing device, to a terminal for display, the terminal being configured to display first search suggestion information indicating the summary information in an information search interface, and to display a search result interface including the current search result.

According to one aspect, one or more embodiments of this disclosure provide an information search method, which is performed by an electronic device and includes: displaying, in response to a current search operation triggered by a target object based on target search information satisfying a preset search condition, first search suggestion information in an information search interface, the first search suggestion information including summary information of a current search result; and the preset search condition being that: the current search operation is related to a historical search operation of the target object; and displaying, in response to a viewing operation triggered based on the first search suggestion information, a search result interface corresponding to the target search information, the search result interface including the current search result; the current search result being generated based on the target search information and contextual corpus information of the target object; and the contextual corpus information including at least one of the following: search information inputted by the target object in each historical search operation, content browsed by the target object in each historical search result, and content of a feedback behavior performed by the target object for browsed content.

According to another aspect, one or more embodiments of this disclosure further provide an information search method, which is performed by an electronic device and includes: acquiring contextual corpus information of a target object, the contextual corpus information including at least one of the following: search information inputted by the target object in each historical search operation, content browsed by the target object in each historical search result, and content of a feedback behavior performed by the target object for browsed content; inputting, after receiving a current search request triggered based on target search information, the target search information and the contextual corpus information into a target language model in response to the current search request satisfying a preset search condition, to generate a current search result and summary information of the current search result, the preset search condition being that: a current search operation is related to the historical search operation of the target object; and feeding back the summary information and the current search result to a client to cause the client to display first search suggestion information containing the summary information in an information search interface, and to display, in response to a viewing operation triggered based on the first search suggestion information, a search result interface containing the current search result.

According to another aspect, one or more embodiments of this disclosure further provide an information search apparatus, including: a first response unit, configured to display, in response to a current search operation triggered by a target object based on target search information satisfying a preset search condition, first search suggestion information in an information search interface, the first search suggestion information including summary information of a current search result; and the preset search condition being that: the current search operation is related to a historical search operation of the target object; and a second response unit, configured to display, in response to a viewing operation triggered based on the first search suggestion information, a search result interface corresponding to the target search information, the search result interface including the current search result; the current search result being generated based on the target search information and contextual corpus information of the target object; and the contextual corpus information including at least one of the following: search information inputted by the target object in each historical search operation, content browsed by the target object in each historical search result, and content of a feedback behavior performed by the target object for browsed content.

According to another aspect, one or more embodiments of this disclosure further provide an information search apparatus, including: an information acquisition unit, configured to acquire contextual corpus information of a target object, the contextual corpus information including at least one of the following: search information inputted by the target object in each historical search operation, content browsed by the target object in each historical search result, and content of a feedback behavior performed by the target object for browsed content; a result generation unit, configured to input, after receiving a current search request triggered based on target search information, the target search information and the contextual corpus information into a target language model in response to the current search request satisfying a preset search condition, to generate a current search result and summary information of the current search result, the preset search condition being that: a current search operation is related to the historical search operation of the target object; and a feedback unit, configured to feed back the summary information and the current search result to a client to cause the client to display first search suggestion information containing the summary information in an information search interface, and to display, in response to a viewing operation triggered based on the first search suggestion information, a search result interface containing the current search result.

According to another aspect, one or more embodiments of this disclosure further provide an electronic device, including processing circuitry (e.g., a processor) and a memory. The memory includes a non-transitory computer-readable storage medium that has a computer program stored therein, and the computer program, when executed by the processor, causes the processor to perform operations of any one of the foregoing information search methods.

According to another aspect, one or more embodiments of this disclosure further provide a non-transitory computer-readable storage medium, including a computer program which, when runs on an electronic device (e.g., processing circuitry included in the electronic device), is configured to cause the electronic device to perform operations of any one of the foregoing information search methods.

According to another aspect, one or more embodiments of this disclosure further provide a computer program product, including a computer program stored in a non-transitory computer-readable storage medium. Processing circuitry (e.g., a processor) of an electronic device, when reading the computer program from the non-transitory computer-readable storage medium, executes the computer program to cause the electronic device to perform operations of any one of the foregoing information search methods.

### BRIEF DESCRIPTION OF THE DRAWINGS

FIG. 1 is a schematic diagram of an application scene according to an embodiment of this disclosure.

FIG. 2 is an implementation flowchart of an information search method according to an embodiment of this disclosure.

FIG. 3 is a schematic diagram of an information search interface according to an embodiment of this disclosure.

FIG. 4 is a schematic diagram of a search result interface according to an embodiment of this disclosure.

FIG. 5 is a schematic diagram of target content and intelligent recognition information according to an embodiment of this disclosure.

FIG. 6 is an animation schematic diagram of favoriting target content according to an embodiment of this disclosure.

FIG. 7 is a schematic diagram of first search suggestion information according to an embodiment of this disclosure.

FIG. 8 is a schematic diagram of an artificial intelligence (AI) result list and a map module according to an embodiment of this disclosure.

FIG. 9 is a schematic diagram of a search result according to an embodiment of this disclosure.

FIG. 10 is a schematic diagram of first supplemental notification information according to an embodiment of this disclosure.

FIG. 11 is a schematic diagram of second supplemental notification information according to an embodiment of this disclosure.

FIG. 12 is a schematic diagram of third supplemental notification information according to an embodiment of this disclosure.

FIG. 13 is a schematic diagram of fourth supplemental notification information according to an embodiment of this disclosure.

FIG. 14 is a schematic diagram of a first dialog search mode according to an embodiment of this disclosure.

FIG. 15 is a schematic diagram of a second dialog search mode according to an embodiment of this disclosure.

FIG. 16 is a schematic diagram of a third dialog search mode according to an embodiment of this disclosure.

FIG. 17 is a schematic diagram of another information search interface according to an embodiment of this disclosure.

FIG. 18 is a schematic diagram of another target content and intelligent recognition information according to an embodiment of this disclosure.

FIG. 19 is a schematic diagram of still another target content and intelligent recognition information according to an embodiment of this disclosure.

FIG. 20 is a schematic diagram of a questioning process according to an embodiment of this disclosure.

FIG. 21 is a schematic diagram of an answer interface according to an embodiment of this disclosure.

FIG. 22 is a schematic diagram of another first search suggestion information according to an embodiment of this disclosure.

FIG. 23 is a schematic diagram of still another first search suggestion information according to an embodiment of this disclosure.

FIG. 24 is a schematic diagram of a content summarization process according to an embodiment of this disclosure.

FIG. 25 is a schematic diagram of another content summarization process according to an embodiment of this disclosure.

FIG. 26 is an implementation flowchart of another information search method according to an embodiment of this disclosure.

FIG. 27 is a schematic flowchart of a network search realizing a plurality of rounds of AI searches according to an embodiment of this disclosure.

FIG. 28 is a schematic structural diagram of an information search apparatus according to an embodiment of this disclosure.

FIG. 29 is a schematic structural diagram of another information search apparatus according to an embodiment of this disclosure.

FIG. 30 is a schematic structural diagram of hardware of an electronic device according to an embodiment of this disclosure.

FIG. 31 is a schematic structural diagram of hardware of another electronic device according to an embodiment of this disclosure.

### DESCRIPTION OF EMBODIMENTS

To describe the objectives, technical solutions, and advantages of embodiments of this disclosure, the technical solutions of this disclosure are described below with reference to the accompanying drawings of this disclosure. The described embodiments in this disclosure are merely some non-limiting examples of the technical solutions of this disclosure. Other embodiments are within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Descriptions of terms in this disclosure are provided as examples only and are not intended to limit the scope of the disclosure.

Contextual corpus information: this term may correspond to a new corpus proposed in one or more embodiments of this disclosure, and may provide context used during the search for an object (e.g., a user of the search operation or service). In some embodiments, a final search result may be generated by integrating the target search information and the contextual corpus information of a search for the object. In one or more embodiments of this disclosure, for a target object (e.g., a user), contextual corpus information of the target object may include at least one of the following: search information inputted by the target object in each historical search operation, content browsed by the target object in each historical search result, and content of a feedback behavior performed by the target object for browsed content. The feedback behavior may correspond to an interactive operation behavior generated by the target object when browsing content, such as actively favoriting, liking, giving a thumbs-up, forwarding, sharing, and commenting. In some examples, “favoriting” in this disclosure may correspond to storing or identifying a piece of content or information as being added to a favorite database or having the “favorite” status indicating an increased importance or priority to the corresponding user.

Search suggestion information: this term may correspond to suggestion information (also referred to as “sug” for short) that may be dynamically displayed when an object performs a network search. According to a change of a search request/search word (query) inputted by the object, suggestions generated by AI may also change accordingly. In one or more embodiments of this disclosure, first search suggestion information may include summary information of a current search result displayed when it is determined that a preset search condition is satisfied during one search. Second search suggestion information may include summary information corresponding to a search topic during summarization.

Supplemental notification information: this term may correspond to notification information related to at least one of date information and place information in the target search information. In one or more embodiments of this disclosure, the supplemental notification information may include, but is not limited to, at least one of the following: date-related weather information, date-related travel clothing information, date-related festival activity information, date-related traffic restriction information, place-related visit restriction information, and place-related welfare information.

Intelligent recognition information: this term may correspond to information obtained by performing intelligent recognition on target content selected by the target object, and may include, but is not limited to, at least one of the following: key information contained in the target content, a type of the target content, and importance of the target content.

Embodiments of this disclosure relate to AI and machine learning (ML) technologies, and are designed based on natural language processing (NLP) and ML in AI as non-limiting examples.

A target language model in one or more embodiments of this disclosure may be trained using the ML or deep learning technology, and may correspond to a large language model (LLM) or a multimodal large language model (MLLM). The trained target language model may generate a corresponding answer for a question, thereby realizing a network search and an intelligent dialog. The training manner may be online training or offline training. This is not limited herein.

When the object (e.g., a user) searches for a problem through a search engine, the search engine recalls content across the whole network through a search request, scores and sorts recalled content, and displays the recalled content to the object in an order of priorities. However, when the object encounters a relatively complex search task, in a network search, progressive in-depth answers cannot be provided based on context of a plurality of questions of the object. The object needs to perform a plurality of cross-platform searches, then independently process information and content obtained after each search, and finally obtain, through summarization, a result meeting the requirements. The entire search process is cumbersome, resulting in low search efficiency.

However, in some examples, LLM-based dialog searches also have some problems. Still using the foregoing travel guide scene as an example, the LLM-based dialog search is used. When the object queries a travel itinerary guide for a place, the LLM may directly provide a final complete answer to the object according to an algorithm of the LLM. However, places and content involved in the answer cannot be customized to generate an itinerary according to the object's personal preferences. Consequently, the given answer is not practical, and the object still needs to perform summarization. In this way, the entire process is cumbersome.

In summary, a current network search or dialog search cannot generate a more personalized search result according to the requirements, preferences, and the like of the object. Consequently, the object may have to perform a plurality of searches and then summarize, resulting in low search efficiency.

In view of this, one or more embodiments of this disclosure propose an information search method and apparatus, an electronic device, a storage medium, and a program product. In some embodiments of this disclosure, based on network search experience, each time an object performs a search, search information inputted by the object, content browsed by the object in each search result, and content of a feedback behavior performed by the object are collected to construct contextual corpus information of the object. Further, when the object searches based on target search information, whether a current search operation is related to a previous historical search operation is first analyzed. If yes, the contextual corpus information of the object and target search information currently inputted by the object are inputted into a target language model, and a capability of the target language model is adopted to provide a current search result that is obtained after a plurality of rounds of information processing and that meets personal preferences of the object.

In addition, when it is determined that the current search operation is related to the previous historical search operation, first search suggestion information is dynamically displayed in an information search interface, notifying the object that this search is related to a previous search, and notifying the object with summary information of the current search result, so as to display, after determining that the object clicks to view the first search suggestion information, the current search result generated after a plurality of rounds of information processing. In this manner, even for some complex search problems, the objects do not need to perform a plurality of cross-platform searches. Instead, answers meeting requirements of the object are automatically generated with reference to the personalized corpus information of the object, thereby effectively improving the information search efficiency of the object.

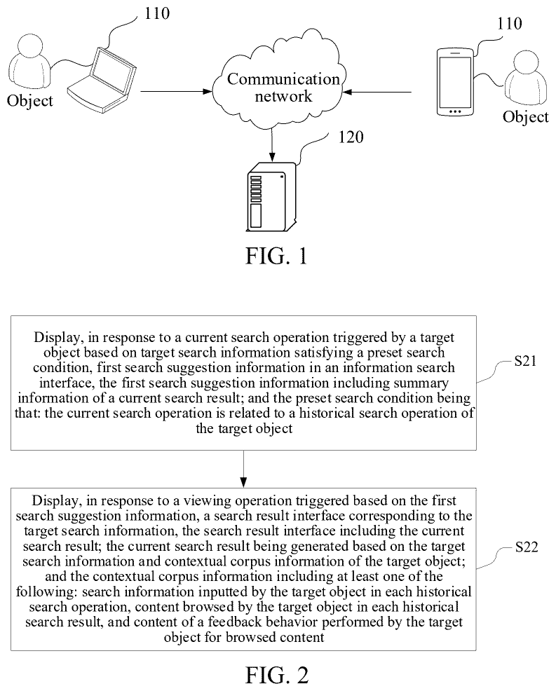

FIG. 1 is a schematic diagram of an application scene according to an embodiment of this disclosure. The diagram of the application scene includes two terminal devices 110 and one server 120.

In one or more embodiments of the present disclosure, the terminal device 110 includes, but is not limited to, devices such as a mobile phone, a tablet computer, a laptop computer, a desktop computer, an e-book reader, an intelligent voice interaction device, a smart home appliance, and an in-vehicle terminal. The terminal device may be installed with an information search-related client. The client may be software (such as a browser), a web page, a mini program, or the like. The server 120 is a backend server corresponding to software, a web page, a mini program, or the like, or is a server configured to perform information search. This is not limited in this disclosure.

The information search method in one or more embodiments of this disclosure may be performed by an electronic device, and the electronic device may be the terminal device 110 or the server 120. That is, the method may be performed by the terminal device 110 or the server 120 alone, or may be performed by the terminal device 110 and the server 120 together. For example, when the method is performed by the terminal device 110 and the server 120 together, for example, the terminal device 110 is installed with an information search-related client, such as a browser, and a target object may search in the browser. Each time the target object searches, the server 120 may collect statistics on search information inputted currently, content browsed by the target object in a current search result, and content of a feedback behavior (such as giving a thumbs-up, favoriting, liking, forwarding, or sharing) performed by the target object to construct contextual corpus information of the object.

Further, when the target object searches based on target search information, the browser transmits, in response to a search operation triggered by the target object based on the target search information, a search request to the server 120 through the terminal device 110. After receiving the search request triggered based on the target search information, the server 120 analyzes whether a current search operation is related to a previous historical search operation. If yes (that is, satisfying a preset search condition), the server 120 inputs the target search information and the contextual corpus information into a target language model to generate a current search result and summary information of the current search result, and feeds back the current search result and the summary information to the terminal device 110. The terminal device 110 displays first search suggestion information containing the summary information in an information search interface through the browser. Then, in response to a viewing operation triggered based on the first search suggestion information, the browser may display a search result interface corresponding to the target search information. The search result interface contains the current search result.

In an implementation, the terminal device 110 may communicate with the server 120 through a communication network. The communication network is a wired network or a wireless network. In at least one embodiment of this disclosure, when there are a plurality of servers, the plurality of servers may form a blockchain, and the servers are nodes on the blockchain. For example, according to the information search method disclosed in at least one embodiment of this disclosure, information search-related data, such as contextual corpus information, target search information, target content, a first question, first answer information, a second question, second answer information, a third question, and third answer information, may be stored in the blockchain. In addition, at least one embodiment of this disclosure may be applied to various scenes, including but not limited to, cloud technology, AI, intelligent transportation, and assisted driving.

FIG. 2 is an implementation flowchart of an information search method according to an embodiment of this disclosure. The method is performed by an electronic device, for example, the terminal device 110 in FIG. 1, and more specifically, is performed by a client (for example, a browser) in the terminal device 110. In some embodiments, an implementation procedure of the method is shown as S21 to S22.

S21: Display, in response to a current search operation triggered by a target object based on target search information satisfying a preset search condition, first search suggestion information in an information search interface, the first search suggestion information including summary information of a current search result; and the preset search condition being that: the current search operation is related to a historical search operation of the target object.

In some examples, target search information of a current search operation is received by processing circuitry of a processing device. First search suggestion information is displayed in an information search interface on a display of the processing device when the target search information is related to one or more historical search operations, the first search suggestion information indicating summary information of a current search result based on the target search information and the one or more historical search operations.

In some embodiments, each time the object performs a network search, the current search operation of the object is compared with a previous historical search operation of the object to analyze whether there is a related search behavior before. Using the target object as an example, current search information inputted by the target object during the current search may be recorded as the target search information. In some embodiments, the target search information may be compared with search information, a search result, and the like that correspond to the previous historical search operation of the target object to analyze whether they are related.

The “related” refers to a commonality between two search operations. The commonality may refer to search information containing a same or similar keyword (such as a person name, a place name, or an institution name), search information being semantically similar, search information being semantically opposite (which may be understood as a commonality in some embodiments, and may be semantically related), or the like. Details are not described herein again.

In at least one embodiment of this disclosure, according to a change of search information inputted by the object, search suggestion information generated by AI also changes correspondingly. At the moment the object inputs the search information, the object is notified with search suggestion information provided by AI, providing a quick preview of a search result for the object. Then, the object may determine whether to view the search result generated by AI with reference to the contextual corpus information.

S22: Display, in response to a viewing operation triggered based on the first search suggestion information, a search result interface corresponding to the target search information, the search result interface including the current search result; the current search result being generated based on the target search information and contextual corpus information of the target object; and the contextual corpus information including at least one of the following: search information inputted by the target object in each historical search operation, content browsed by the target object in each historical search result, and content of a feedback behavior performed by the target object for browsed content.

In some examples, the current search result is obtained by the processing circuitry of the processing device based on a user operation on the first search suggestion information displayed in the information search interface. In some examples, the current search result being generated based on the target search information and contextual corpus information that includes (i) historical search information of the one or more historical search operations, (ii) browsed content from each historical search result of the one or more historical search operations, or (iii) records of feedback behaviors performed in association with the browsed content. In some examples, the current search result is displayed in a search result interface on the display.

The search information refers to a search request inputted by the target object when performing a network search, for example, a search word inputted by the target object in a search box. The feedback behavior refers to an interactive operation behavior generated by the target object when browsing content, such as actively favoriting, liking, giving a thumbs-up, forwarding, sharing, and commenting.

In some embodiments, in each network search process of the target object, the foregoing several types of information may be collected, thereby continuously enriching the contextual corpus information corresponding to the target object, for subsequent generation of a personalized search result.

In at least one embodiment of this disclosure, the current search result may be generated based on a target language model (for example, the LLM). In some embodiments, each time the target object performs a network search, the current search operation may be compared with the previous historical search operation. When it is determined that the preset search condition is satisfied, the target search information currently inputted by the target object and currently collected contextual corpus information are inputted together into the target language model. Through an answer generation capability of the target language model, with reference to the contextual corpus information, a search result (that is, the current search result) that is obtained after a plurality of rounds of information processing and that meets personal preferences is generated at a time.

In at least one embodiment of this disclosure, the object may determine whether to view the search result generated by the AI with reference to the contextual corpus information by browsing the first search suggestion information generated by AI. When the object determines that the search result needs to be viewed, the current search result generated by AI may be viewed based on the viewing operation triggered based on the first search suggestion information. In some embodiments, the object may trigger the viewing operation by clicking the first search suggestion information, long-pressing the first search suggestion information, or the like. Details are not described herein again.

In this disclosure, based on network search experience, with reference to the target language model, each search problem performed by the object in the browser, browsed content in the search result, content that the object actively gives a thumbs-up to and favorites, and the like are all provided to the target language model as the contextual corpus information. The target language model may, using the capability of the target language model with reference to the contextual corpus information customized to the object, provide the object with the search result that is obtained after a plurality of rounds of information processing and that meets personal preferences, thereby resolving a problem that the current network search can only support a single search and fails to support a plurality of rounds of searches.

In addition, this disclosure further resolves a problem that the target language model cannot provide answers based on a personalized corpus of the object. In this disclosure, active and passive operations of the object for content in the network search are provided to the target language model as the personalized corpus of the object, so that the target language model may provide a personalized solution for the object.

In addition, this disclosure further resolves the mutual integration of the network search and the target language model: when using the network search, the object can view results screened by AI at any time by clicking AI search suggestion information.

The following uses travel and word query scenes as examples. The information search method in at least one embodiment of this disclosure will be described in detail with reference to the accompanying drawings.

### (1) Travel Scene.

An example in which the target object first searches for “travel guide for city A” and then searches for “hotel in city A” is used below.

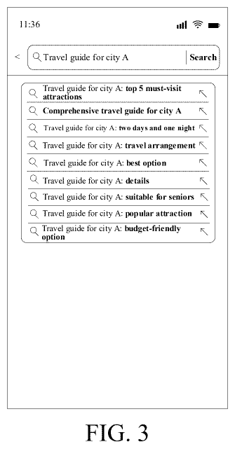

FIG. 3 is a schematic diagram of an information search interface according to an embodiment of this disclosure. FIG. 3 shows the target object's first search for “travel guide for city A”. It is assumed that the object has not previously searched for travel-related or city A-related content, that is, there is no historical search operation related to a current search operation currently, and a preset search condition is not satisfied. Therefore, in this case, first search suggestion information does not need to be displayed in an information search interface.

After the target object performs a network search based on the currently inputted search information “travel guide for city A”, a common search result interface may be displayed. Search results in the search result interface are displayed in an order of priorities after a search engine recalls content across the whole network based on “travel guide for city A” and scores and sorts the recalled content.

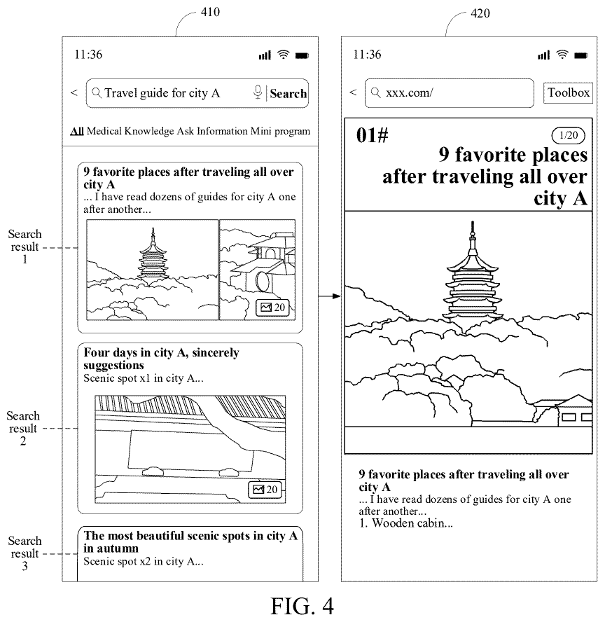

FIG. 4 is a schematic diagram of a search result interface according to an embodiment of this disclosure. As shown in a left interface 410 in FIG. 4, several search results recalled and sorted according to the foregoing manner, such as a search result 1 “9 favorite places after traveling all over city A”, a search result 2 “four days in city A, sincerely suggestions”, and a search result 3 “the most beautiful scenic spots in city A in autumn”, are listed. The target object may slide up the interface to view more search results, or may click to view a specific search result. If the object selects the search result 1, a detail page 420 of the search result 1 shown on the right side of FIG. 4 may be jumped to.

In at least one embodiment of this disclosure, if the target object selects an article of interest in the search result interface for browsing, browsed and favorite content of the target object may be automatically recorded, and then created as a personalized corpus of the object (that is, an expression form of personalized corpus information herein).

In at least one embodiment of this disclosure, the favorite content of the target object may not only include content that the target object actively favorites, but also may include content that the target object likes, gives a thumbs-up to, comments on, forwards, shares, or the like. In addition, when browsing the search result, the target object may further identify and ask questions about partial content in the search result. At least one embodiment of this disclosure further supports intelligent favoriting of the partial content to enrich the dimension of the favorite content of the target object.

In some embodiments, when browsing an article, the target object may be interested in partial content in the article, and AI-based intelligent recognition or AI-based intelligent favoriting may be performed on such content. An implementation is as follows: in response to a content selection operation triggered based on the search result interface, a client identifies currently selected target content and intelligent recognition information corresponding to the target content in the search result interface. The intelligent recognition information includes, but is not limited to, at least one of the following: key information contained in the target content, a type of the target content, and importance of the target content. The key information contained in the target content may refer to a person, a place, an institution, a specialty food, a special activity, a special event, or the like.

In at least one embodiment of this disclosure, for any search operation, the target object may further view details of the search result interface. For example, the target object views a specific search result in the search result interface, enters a detail page (belonging to another search result interface in at least one embodiment of this disclosure) of the search result, and further performs a content selection operation in the detail page. In response to the content selection operation of the target object, in addition to identifying the currently selected target content in the search result interface, the client may further display intelligent recognition information corresponding to the target content.

In some embodiments, the intelligent recognition information may be in a form of a picture, text, picture-text, a video, an icon, a label, an animation, or the like. This is not limited herein. A label is used as an example for illustration.

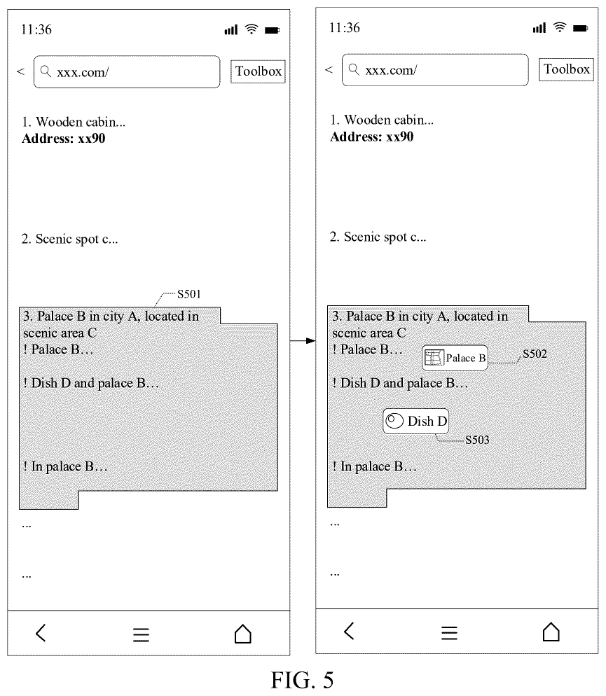

FIG. 5 is a schematic diagram of target content and intelligent recognition information according to an embodiment of this disclosure. For example, when browsing an article about the listed search result 1 “9 favorite places after traveling all over city A”, the target object is interested in a scenic spot and a route mentioned in the article. After a content area is double-clicked, a paragraph double-clicked by the object may be selected in the interface, for example, S501 identified by a gray area in FIG. 5.

Herein, if a selected range is inaccurate, the target object may manually drag upper and lower edges of the selected region to expand or shrink the selected range.

After the target object has no operation, a recognition animation may appear in the interface to notify the object that “AI is recognizing selected content” (not shown in FIG. 5). After the recognition animation ends, information such as a place recognized by AI may be identified in the interface and displayed in the form of labels, as shown in S502 and S503 in the right interface in FIG. 5. S502 represents a recognized place “palace B”, and S503 represents a recognized local specialty food “dish D”.

In at least one embodiment of this disclosure, different pieces of intelligent recognition information may be tagged in different styles. For example, different types of places are tagged in different colors, and so on. Details are not described herein again.

In some embodiments, in addition to intelligently recognizing the target content and tagging the intelligent recognition information, the target content may further be automatically favorited. In some embodiments, a part of content selected by the target object is favorited. During favoriting, AI analyzes and labels favorite content using a target language model, and intelligently classifies content that the target object is interested in. A classification label may be used in the retrieval of the personalized corpus of the object during an AI dialog, and there is a related introduction on the server. Details are not described herein again.

In addition, a corresponding favorite animation is displayed in the search result interface. A favorite animation indicates that the target content flies into a favorite control (e.g., a favorite control element) in the search result interface. In this process, the target content may further be gradually shrunk, giving the target object a feeling that it is becoming smaller and smaller until it finally becomes small enough to fit into the favorite control.

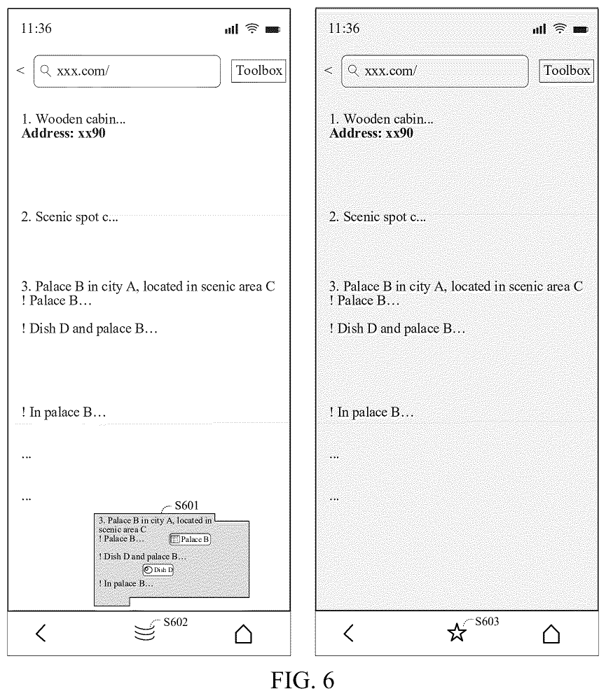

FIG. 6 is an animation schematic diagram of favoriting target content according to an embodiment of this disclosure. An interface shown in the left side of FIG. 6 represents a frame in a process in which target content S601 flies into a favorite control 602 in the search result interface. In this process, S601 not only contains target content, but also contains labels recognized by AI, such as palace B and dish D. After the target content S601 thoroughly flies into the favorite control 602, the style shown in S602 is updated to the style shown in S603.

In at least one embodiment of this disclosure, the target object may click the favorite control to view favorites of the target object. In the favorites of the target object, intelligent recognition information may further be identified in the same or similar manner as described above. For example, the intelligent recognition information is still identified in a label manner, to facilitate subsequent generation of an answer.

In some embodiments, the client may further display a corresponding favorite interface in response to a viewing operation for the favorite content of the target object, and tag different classification labels through different tagging styles in the favorite interface. For a recurring classification label, a quantity of recurring times is tagged at a preset location in the favorite interface. In some embodiments, these classification labels may be place labels, time labels, event labels, item labels, and the like, and may refer to related descriptions on the server. Details are not described herein again.

In the foregoing implementation, a manner for favoriting partial content is provided for the object. In addition, in some applications, when favoriting content, only the text or picture can be favorited, but the favorite content cannot be classified or recognized. However, in the foregoing implementation, an object may see a label made by AI for key content when favoriting content, facilitating the object to better favorite, collate, and understand the content.

FIG. 5 and FIG. 6 show related operations performed on the search results when the target object performs a first search. The target object may perform the foregoing operation on the search result when performing any subsequent search. For example, the target object may perform the foregoing operation on the search result when subsequently performing searches related to “city A”, “travel”, or the like. Various implementations are based on those in one or more of the foregoing embodiments, and details are not further described.

It is assumed that after the first search for “travel guide for city A”, the target object performs a second search. The target object searches for “hotel in city A” this time. This search is related to a previous search for “travel guide for city A”, both belonging to search operations related to city A. Therefore, in at least one embodiment of this disclosure, when the target object searches for “hotel in city A”, that is, a preset search condition is satisfied, first search suggestion information may be dynamically displayed in the information search interface in the search process.

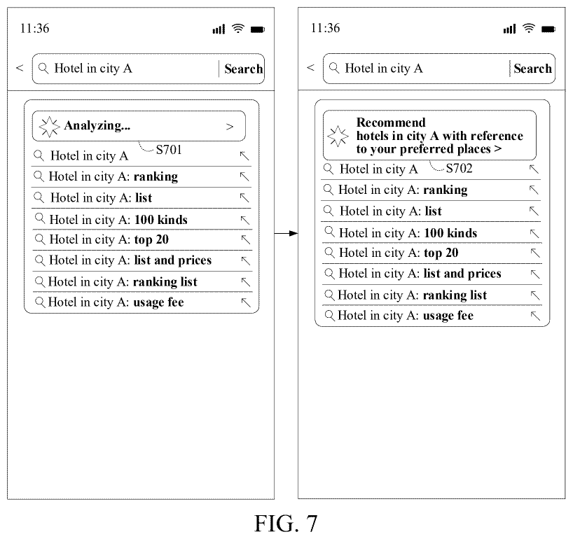

FIG. 7 is a schematic diagram of displaying first search suggestion information according to an embodiment of this disclosure. In the search process, first search suggestion information may be displayed in an information search interface shown in FIG. 7, notifying that related hotels in city A are screened for the target object. As shown in S701 and S702 in FIG. 7, first search suggestion information shown in S701 represents a current processing progress, that is, an appropriate hotel has not been found yet, and the system is currently in an analysis stage. After the analysis is completed, first search suggestion information shown in S702 may be displayed, to notify the target object with summary information of the current search result, for example, “recommend hotels in city A with reference to your preferred places >” in S702.

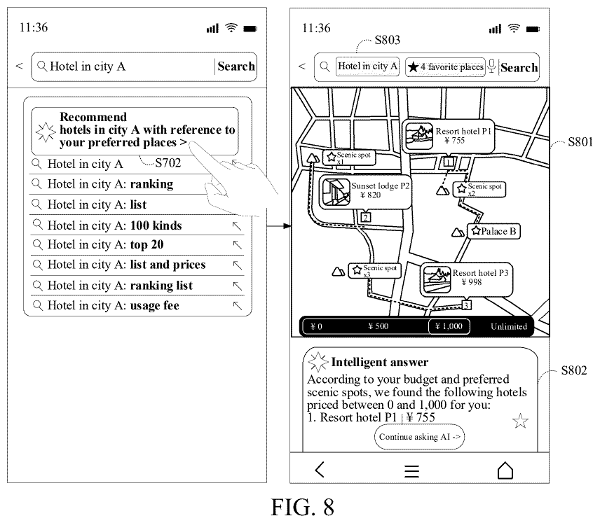

In at least one embodiment of this disclosure, the target object may click the first search suggestion information shown in S702, to enter a search result interface and display an AI result list. FIG. 8 is a schematic diagram of an AI result list and a map module (e.g., a map element) according to an embodiment of this disclosure. The AI result list includes scenic spots, routes, and hotels near shops that are screened by AI and that have been favorited or followed by the target object in previous browsing, and is an AI personalized screening result meeting the requirements of the target object.

In an information search process, in addition to displaying the first search suggestion information, such search suggestion information (which may be recorded as third search suggestion information in some embodiments) representing a generation progress of the search result as shown in S701 may further be displayed.

In addition, in a plurality of network searches of the target object, the target language model may screen the current search result for the object through cross-screening of a plurality of previous search words of the object, and present the current search result in an appropriate form according to a screened content type. In some embodiments, a plurality of search words are compared with each other to provide a result after the comparison.

For example, if the target search information is related to a geographic location, a map module may further be set in the search result interface. The map module is configured to display at least one of the following: favorite places related to the geographic location in favorite contents of the target object, recommended places that are determined based on a preset recommendation rule and related to the target search information, and travel routes between the favorite places and the recommended places. Further, the current search result in the search result interface includes information of each recommended place, and at least one web page associated with the recommended place.

In some examples, when the target search information is related to a geographic location, the search result interface includes a map element. In some examples, the map element is configured to display one or more of a favorite place related to the geographic location in stored favorite content, a recommended place based on a preset recommendation rule and the target search information, or a travel route between the favorite place and the recommended place. In some examples, the current search result includes information of the recommended place and at least one web page associated with the recommended place.

Still using FIG. 8 as an example, S801 is an example of a map module in this embodiment of this disclosure. In an example shown in FIG. 8, content screened by AI is related to a geographic location “city A”, and a map module shown in S801 is added. A favorite place of the target object and a place of a hotel recommended by AI are simultaneously displayed on the map module S801, and a route between the two places is tagged. For example, in S801, favorite places of the target object include scenic spot x1, scenic spot x2, scenic spot x3, and palace B, and places recommended by AI include resort hotel P1, sunset lodge P2, and resort hotel P3.

In addition, routes between the favorite places and the recommended places are further tagged on the map module. In some embodiments, according to distances between these places, a feasible route may be tagged among places having relatively close distances within a particular range. For example, there is a recommended route among resort hotel P1→scenic spot x2→palace B, a recommended route between sunset lodge P2→scenic spot x1, and a recommended route between resort hotel P3→scenic spot x3. The three recommended routes are shown by dashed lines in S801. There may be repeated places of the favorite places of the target object and the places recommended by AI. This is not limited herein.

A range of hotel prices is further displayed in the map module shown in S801. For example, prices of the three recommended hotels in S801 are between 0 yuan and 1,000 yuan. The price range may be obtained through statistical analysis of historical reservation records of the target object and the like, or may be a default price range. This is not limited herein.

Further, a list of the hotels screened by AI is displayed in S802. Display of the hotel list includes two elements: one is basic information of the hotel (that is, the information of the recommended place), and the other is a web page (that is, at least one web page associated with the recommended place) that mentions the hotel and that is screened by AI. One hotel may be associated with a plurality of web page results, to help the target object determine whether it is interested in the current hotel.

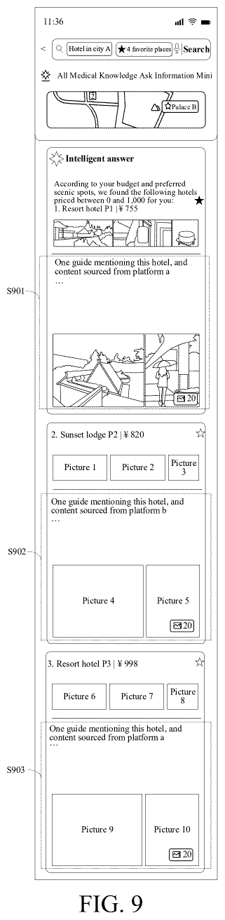

An example in which each hotel is associated with one web page result is used below. Details of S802 may refer to FIG. 9. FIG. 9 is a schematic diagram of a search result according to an embodiment of this disclosure. The hotel list shown in FIG. 9 sequentially introduces resort hotel P1, sunset lodge P2, and resort hotel P3. Basic information of a hotel is information such as a name, a price, a geographic location, and some building pictures of the hotel. In addition, each hotel further correspondingly displays at least one web page result. For example, there is one guide mentioning resort hotel P1, and content is sourced from a platform a. Content of the web page result is shown in S901 (represented by an ellipsis . . . ). Similarly, there is one guide mentioning sunset lodge P2, and content comes from a platform b. Content of the web page result is shown in S902 (represented by an ellipsis . . . ). There is one guide mentioning resort hotel P3, and content is sourced from the platform a. Content of the web page result is shown in S903 (represented by an ellipsis . . . ).

In the foregoing implementation, the object may screen content more efficiently. Screening does not need to be performed from results across the whole network, but may be performed with reference to other sorted content. In addition, the AI-based intelligent filtering may use different components according to different forms of input content of the object, for example, the map listed above. Compared with the network search and the target language model dialog, content may be presented more intuitively.

In some embodiments, after the viewing operation triggered by the target object based on the first search suggestion information, the search result interface corresponding to the target search information may be displayed. Meanwhile, the current search result in the search result interface is generated based on both target search information and contextual corpus information, which is different from a network search in which matching and recalling are directly performed on whole network content based on the target search information. Therefore, search information in a search information input area in the search result interface may further be updated, to more intuitively reflect the difference between the AI-based intelligent screening and the network search to the target object.

The search result interface further includes a search information input area. An implementation is as follows: updating display in the search information input area from displaying the target search information to displaying the target search information and a quantity of target favorite contents, the target favorite contents being contents related to the current search operation in the favorite contents of the target object.

Still using FIG. 8 as an example, a search information input area in FIG. 8 is a search box shown in S803. Search information in the search box is originally to be target search information, for example, “hotel in city A” shown in the left interface of FIG. 8. However, in S803, the search information is updated to display two parts. One part is the target search information “hotel in city A”, and the other part is “4 favorite places”.

In the foregoing implementation, on a result page of AI screening, content in the search box is updated to “search word inputted by target object” and “※ favorites”, notifying the target object that a result of current AI screening is generated with reference to the search word currently inputted by the object and previous favorite places of the object, so as to better meet preferences of the target object and better meet personalized requirements of the target object.

Another implementation is as follows: updating the display in the search information input area from displaying the target search information to displaying the first search suggestion information. For example, the search information in S803 is directly updated to “recommend hotels in city A with reference to your preferred places”. In this manner, the target object may be more directly notified that the result of the current AI screening is generated with reference to the search word currently inputted by the object and the preferences of the object, so as to better meet the preferences of the target object and better meet the personalized requirements of the target object.

The two search information update manners listed above are merely simple examples. In addition, any update manner that can notify the object that the result of the current AI screening is generated with reference to the search word currently inputted by the object and the preferences of the object is applicable to at least one embodiment of this disclosure. Details are not described herein.

In at least one embodiment of this disclosure, the result of AI screening may further be intelligently reminded. That is, in addition to screening content according to personalized information provided by the object, additional reminding information may further be matched according to content that is searched for. An implementation is as follows: further displaying supplemental notification information matching (or associated with) the current search result in the search result interface, the supplemental notification information being notification information related to (or indicating) date information and/or place information in the target search information.

In this search process, if the date information is involved, supplemental notification information related to the date may further be generated. Similarly, if the place information is involved, supplemental notification information related to the place may further be generated. In some embodiments, when both date information and place information are involved, in addition to the foregoing independent generation manner, supplemental notification information related to both the date and the place may further be generated.

In one or more embodiments of this disclosure, the supplemental notification information includes, but is not limited to, at least one of the following: date-related weather information, date-related travel clothing information, date-related festival activity information, date-related traffic restriction information, place-related visit restriction information, and place-related welfare information. In some embodiments, the supplemental notification information may be generated by matching preset notification templates. In addition, the supplemental notification information may be in the form of a picture, text, picture-text, a video, an icon, a label, an animation, or the like.

For example, when the target object provides date information, matched notification templates include, but are not limited to, weather corresponding to the date, travel clothing corresponding to the date, a major festival corresponding to the date, traffic restriction information corresponding to the date, and the like. When the target object does not provide date information, matched notification templates include, but are not limited to, visit restriction information of a scenic spot, welfare information of a merchant, and the like.

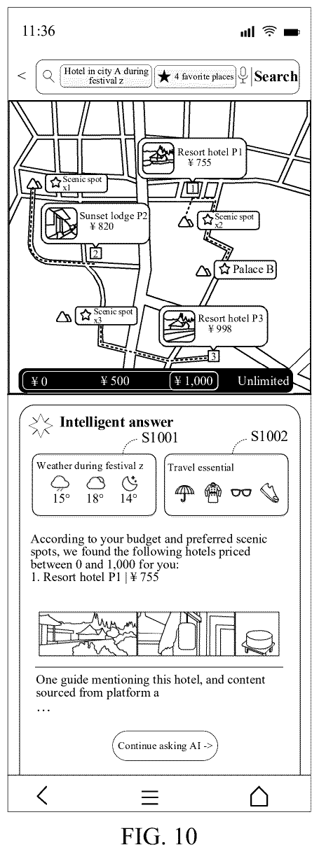

FIG. 10 is a schematic diagram of first supplemental notification information according to an embodiment of this disclosure. In the search result interface shown in FIG. 10, before the hotel list of the intelligent answer, supplemental notification information S1001 and supplemental notification information S1002 are first displayed. For example, the target search information provided by the object contains date information “festival z”, S1001 lists weather information corresponding to the festival z, and S1002 lists travel clothing information corresponding to the festival z.

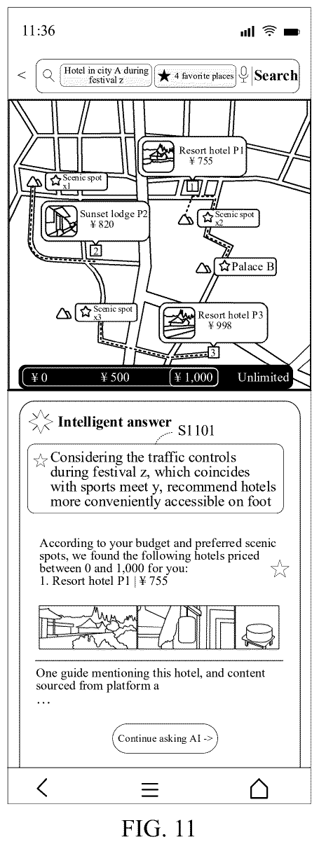

FIG. 11 is a schematic diagram of second supplemental notification information according to an embodiment of this disclosure. In the search result interface shown in FIG. 11, before the hotel list of the intelligent answer, supplemental notification information S1101 is first displayed. For example, the target search information provided by the object contains date information “festival z”, and S1101 lists traffic restriction information corresponding to the festival z. The specific content is “Considering the traffic controls during festival z, which coincides with sports meet y, recommend hotels more conveniently accessible on foot”.

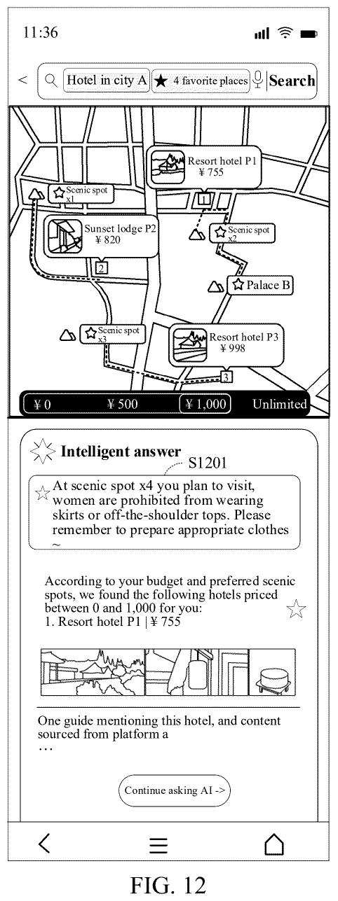

FIG. 12 is a schematic diagram of third supplemental notification information according to an embodiment of this disclosure. In the search result interface shown in FIG. 12, before the hotel list of the intelligent answer, supplemental notification information S1201 is first displayed. For example, the target search information provided by the object does not contain date information, but contains place information “city A”, and some places such as scenic spots and hotels related to city A are further involved in the search process. S1201 lists visit restriction information corresponding to the scenic spot, and specific content is “At scenic spot x4 you plan to visit, women are prohibited from wearing skirts or off-the-shoulder tops. Please remember to prepare appropriate clothes ~”.

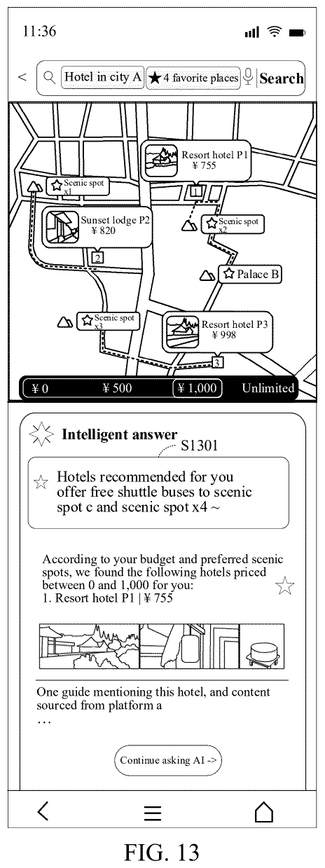

FIG. 13 is a schematic diagram of fourth supplemental notification information according to an embodiment of this disclosure. In the search result interface shown in FIG. 13, before the hotel list of the intelligent answer, supplemental notification information S1301 is first displayed. For example, the target search information provided by the object does not contain date information, but contains place information “city A”, and some places such as scenic spots and hotels related to city A are further involved in the search process. S1301 lists welfare information corresponding to a merchant, and specific content is “Hotels recommended for you offer free shuttle buses to scenic spot c and scenic spot x4~”.

In the foregoing implementation, more personalized information is provided for the object by displaying the supplemental notification information, so that the requirements of the object are better met, and search paths of the object are reduced.

In addition to the foregoing implementation, the information search method in at least one embodiment of this disclosure further supports switching the AI screening result to a dialog search mode. For example, the search result interface is set to further include a first intelligent question and answer entry, and the target object may perform mode switching based on the first intelligent question and answer entry. An implementation is as follows: switching, in response to a dialog operation triggered based on the first intelligent question and answer entry, from an initial network search mode to a dialog search mode; and displaying, in response to a questioning operation for the current search result in the dialog search mode, a first question inputted for the current search result and first answer information corresponding to the first question.

In some embodiments, the target object sees AI content after clicking the first search suggestion information. The target object may continue the AI dialog directly with the target language model through an “AI dialog” entry, or may perform a network search by clicking a search box.

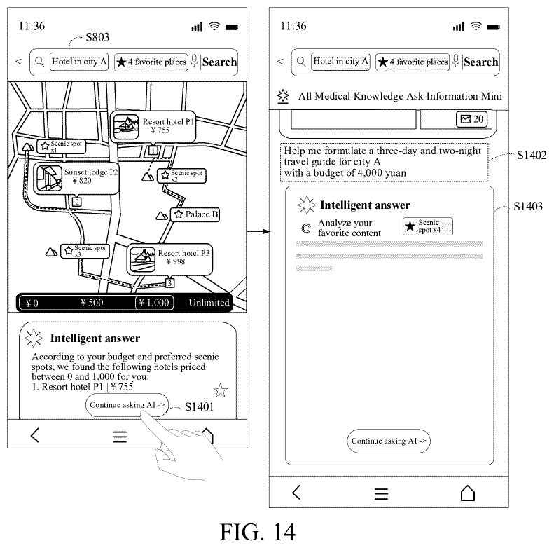

FIG. 14 is a schematic diagram of a first dialog search mode according to an embodiment of this disclosure. As shown in FIG. 14, an intelligent question and answer entry in the search result interface is a “continue asking AI” control in S1401. The target object clicks S1401 in the list of hotels screened by AI to continue the dialog, and then the initial network search mode may be switched to the dialog search mode. The target object may directly continue to ask questions based on the current search result. For example, the target object continues to input a question (which may be understood as a dialog instruction in some embodiments), such as S1402 “Help me formulate a three-day and two-night travel guide for city A with a budget of 4,000 yuan”. AI provides an answer (that is, the first answer information) corresponding to the question (that is, the first question) with reference to the personalized corpus (including favorite content, browsed content, and the like) of the target object, content retrieved on the network, and the target language model. As shown in S1403 in FIG. 14, in an answer generation process, the target object is notified with “analyze your favorite content”, for example, favorite “scenic spot x4” of the target object is currently being analyzed.

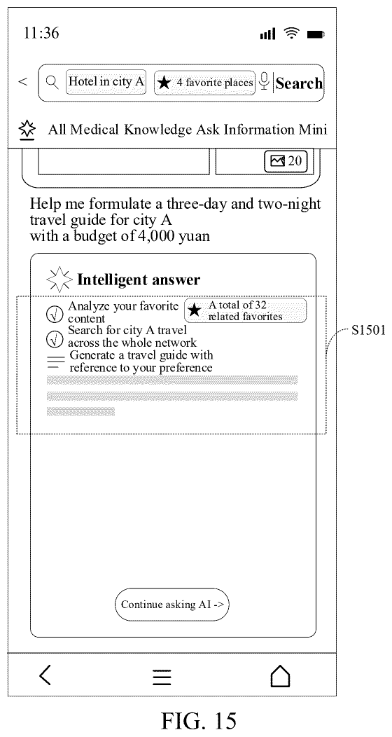

In some embodiments, after all related favorite contents of the target object are analyzed, network retrieval may be performed to search for city A travel-related content across the network. FIG. 15 is a schematic diagram of a second dialog search mode according to an embodiment of this disclosure. S1501 notifies the object that it is currently “generating a travel guide with reference to your preference”. Two operations are sequentially completed before this operation, that is, “analyzing your favorite content” and “searching for city A travel across the whole network”. It also notifies the object that 32 favorite contents are related to the current question through analysis, and an answer is generated with reference to the favorite contents and the content retrieved on the network.

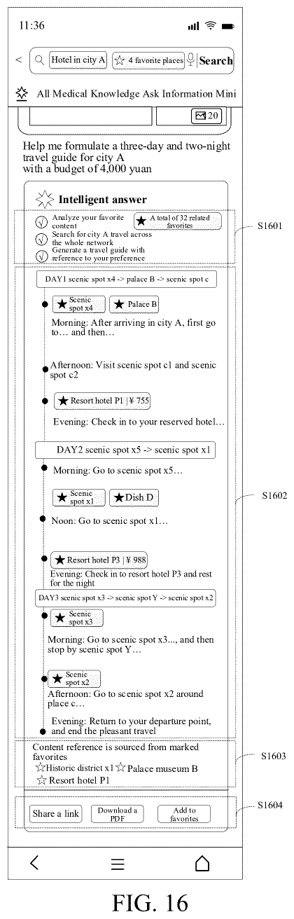

FIG. 16 is a schematic diagram of a third dialog search mode according to an embodiment of this disclosure. S1601 shown in FIG. 16 represents that the foregoing three operations are all completed, and specific content of the generated first answer information is displayed after S1601, that is, a three-day and two-night travel guide for city A with a budget of 4,000 yuan. For example, in S1602, an itinerary for each day, accommodation places, and the like are described in detail. For example, on the first day, the itinerary includes visiting scenic spot x4→palace B→scenic spot c, scheduled according to time periods such as morning, afternoon, and evening. Specific itinerary plans are listed. Similarly, specific itinerary plans are also provided for the second day and the third day, which may refer to FIG. 16. Details are not described herein again.

For the favorite places of the object involved in the generated travel guide, special style identifiers (for example, five-pointed stars) may further be adopted to notify the object that the places are sourced from the favorites of the object. In some embodiments, these identifiers may be directly marked at corresponding locations of the places in the travel guide. In some embodiments, these identifiers may be marked at a unified fixed location, as shown in S1603 in FIG. 16, and they are unified after a specific itinerary plan, identifying that content reference is sourced from marked favorites, such as historic district x1, palace museum B, and resort hotel P1.

In the foregoing implementation, after the object switches to the AI dialog, AI answers the question with reference to the result of the network search, the personalized corpus of the object, and the target language model.

In some embodiments, the search result interface may further include at least one answer operation control. The target object may perform related operations on the generated first answer information based on these operation controls. The client performs, in response to a selection operation for a target answer operation control among the at least one answer operation control, an operation corresponding to the target answer operation control for the first answer information, and displays an execution result of the operation.

Still using FIG. 16 as an example, S1604 shows several answer operation controls listed in this disclosure, which are sharing a link, downloading a PDF, and adding to favorites, respectively. That is, the target object may perform operations such as sharing, downloading, or favoriting on the generated guide content.

In the foregoing implementation, the object may further share, download, or favorite the answer generated by the AI, which not only provides richer interaction manners for the object, but also helps enhance the user engagement, providing more convenience to the object.

In summary, when the object needs to resolve a complex search problem, for example, formulate a travel guide, the object does not need to perform a plurality of cross-platform searches. In this disclosure, progressive in-depth answers may be performed through the context, and the object does not need to independently process information and content obtained after each search. In addition, in a case of formulating a travel guide, involved places and content are formulated according to personal preferences of the object. In this disclosure, based on network search experience, with reference to the target language model, each search problem performed by the object in the browser, browsed content in the search result, content that the object actively gives a thumbs-up to and favorites, and the like are all provided to the target language model as the contextual corpus information. The target language model may, using the capability of the target language model with reference to the corpus customized to the object, provide the object with the search result that is obtained after a plurality of rounds of information processing and that meets personal preferences.

In the foregoing description, using the travel scene as an example, the information search method in at least one embodiment of this disclosure is described in detail. Description is provided below using a word query scene as an example.

### (2) Word Query Scene.

An example in which the target object first searches for the word “artificial” and then searches for the word “naturally” is used below.

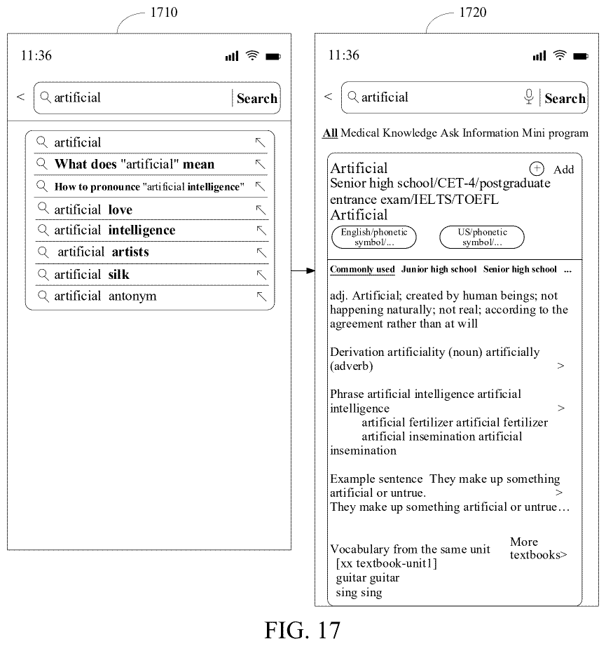

FIG. 17 is a schematic diagram of another information search interface according to an embodiment of this disclosure. In an information search interface 1710, the target object first searches for and queries the word “artificial”. It is assumed that the object has not previously searched for other words, that is, there is no historical search operation related to a current search operation currently, and a preset search condition is not satisfied. Therefore, in this case, first search suggestion information does not need to be displayed in the information search interface 1710.

After the target object performs a network search based on the currently inputted search information “artificial”, a common search result interface may be displayed. A search result in the search result interface is a search result of “artificial” recalled by a search engine based on “artificial”. As shown in a right interface 1720 of FIG. 17, interpretation of the word, related phrases, example sentences, and the like are introduced in detail, and the target object may browse the search result of the word.

Similar to the foregoing travel scene, after the search result is obtained, the target object may further browse the search result. If the target object is interested in partial content in the search result, AI-based intelligent recognition or AI-based intelligent favoriting may be performed on such content. An implementation is as follows: in response to a content selection operation triggered based on the search result interface, a client identifies currently selected target content and intelligent recognition information corresponding to the target content in the search result interface.

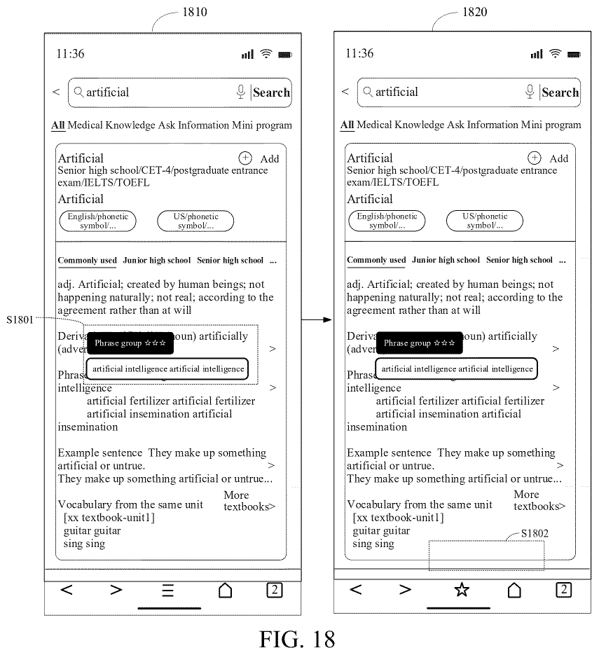

FIG. 18 is a schematic diagram of another target content and intelligent recognition information according to an embodiment of this disclosure. For example, when browsing the foregoing search result, the target object is interested in a phrase “artificial intelligence” mentioned in the search result. After a content area is double-clicked, a phrase double-clicked by the object may be selected in the interface.

After the target object has no operation, a recognition animation may appear in the interface to notify the object that “AI is recognizing selected content” (not shown in FIG. 18). After the recognition animation ends, information such as the type and the importance of the target content recognized by AI may be identified in the interface and displayed in the form of labels. As shown in S1801 in an interface 1810, the type of the target content is “phrase”, and the importance is three stars. In addition, the target content may further be automatically favorited, and a corresponding favorite animation is displayed. S1802 (having the same content as S1801, not shown) shown in a right interface 1820 in FIG. 18 is a frame of the favorite animation in at least one embodiment of this disclosure, indicating that the target content flies into a favorite control.

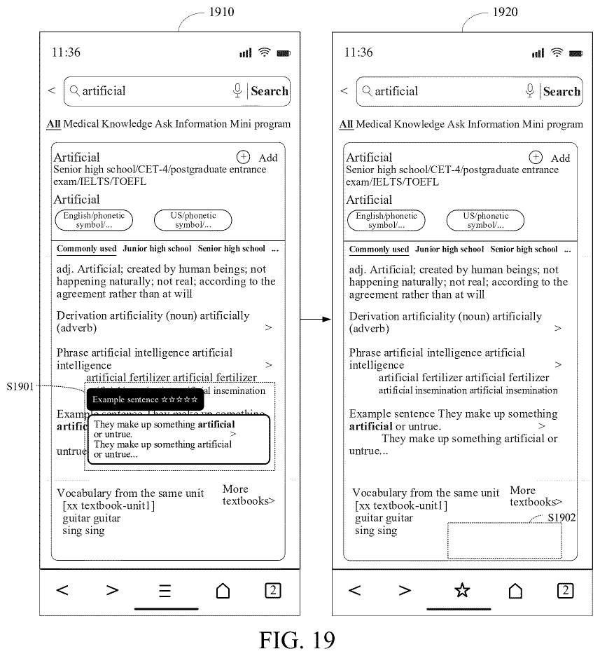

FIG. 19 is a schematic diagram of still another target content and intelligent recognition information according to an embodiment of this disclosure. For example, when browsing the foregoing search result, the target object is interested in an example sentence “They make up something artificial or untrue” mentioned in the search result. After a content area is double-clicked, an example sentence double-clicked by the object may be selected in the interface.

After the target object has no operation, a recognition animation may appear in the interface to notify the object that “AI is recognizing selected content” (not shown in FIG. 19). After the recognition animation ends, information such as the type and the importance of the target content recognized by AI may be identified in an interface 1910 and displayed in the form of labels. As shown in S1901, the type of the target content is an “example sentence”, and the importance is five stars. In addition, the target content may further be automatically favorited, and a corresponding favorite animation is displayed. S1902 (having the same content as S1901, not shown) shown in a right interface 1920 in FIG. 19 is a frame of the favorite animation in at least one embodiment of this disclosure, indicating that the target content flies into a favorite control.

In addition to the foregoing interaction manners, this disclosure further supports the object to perform a multimodal AI search on any content. After browsing any scene in a result page, the object may long-press to select text or a picture, and then ask questions about the selected content. The target language model answers with reference to the selected content and the question of the object.

An implementation is as follows: displaying, in response to a questioning operation for the target content, an answer interface, the answer interface including the target content, a second question inputted for the target content, and second answer information corresponding to the second question.

In at least one embodiment of this disclosure, the target object may further select target content in the process of browsing the search result, and ask questions about the target content through voice input, keyboard input, or the like. For example, when the target object learns a word or browses content of any web page, if the target object has a question about content in the interface, the target object may directly long-press the interface content, and then invokes voice collection. The target object may directly speak the question. After the target object releases the finger, the selected interface content and a question described by the target object are submitted to AI together, and AI returns a result.

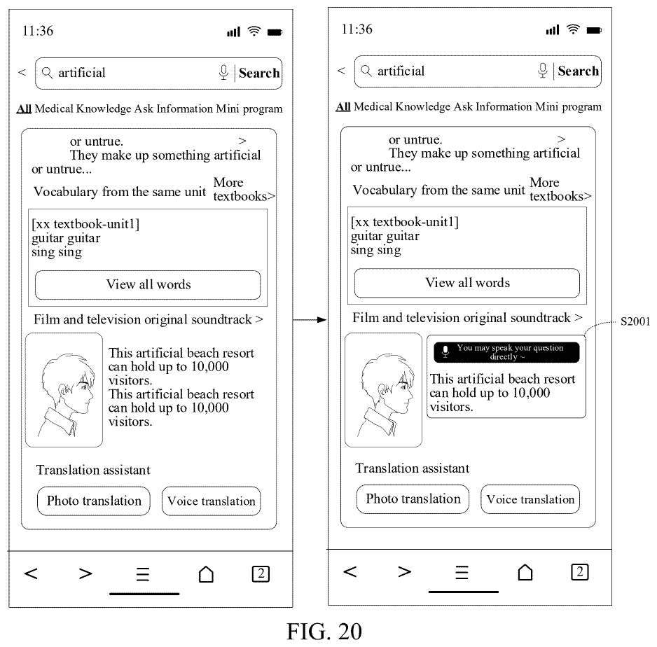

FIG. 20 is a schematic diagram of a questioning process according to an embodiment of this disclosure. FIG. 20 shows that the target object has a question about some content in a search result in the process of browsing the search result of the word “artificial”. The target object may select questionable content as target content through double-clicking, long-pressing, and the like, and further invoke voice collection through double-clicking, long-pressing, and the like, to speak the question. When the target object selects target content “This artificial beach resort can hold up to 10,000 visitors”, the target object is notified with “You may speak your question directly ~”, as shown in S2001 in FIG. 20.

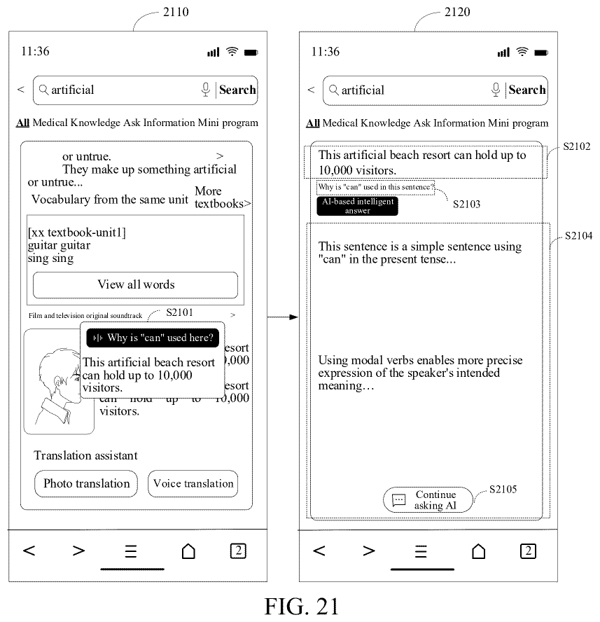

Then, the target object may describe the question by voice. As shown in S2101 in an interface 2110, the target object asks “Why is ‘can’ used here?”. After the target object releases the finger, the selected target content and the second question described by the target object are submitted to AI together. AI feeds back the second answer information and displays an answer interface 2120 shown on the right side of FIG. 21. The answer interface 2120 includes the target content, as shown in S2102, further includes the second question inputted for the target content, as shown in S2103, and the second answer information corresponding to the second question, as shown in S2104.

In some embodiments, search information in a search information input area in the answer interface may be updated to the second question, or updated to the target content+the second question, or the like. This is not limited herein. In the foregoing implementation, the object may perform a multimodal AI search at any location, so that a path of object operation may be shortened, and experience of searching anywhere may be realized.

In some embodiments, the answer interface may further include a second intelligent question and answer entry, and the target object may perform mode switching based on the second intelligent question and answer entry. An implementation is as follows: switching, in response to a dialog operation triggered based on the second intelligent question and answer entry, from the initial network search mode to the dialog search mode; and displaying, in response to a questioning operation for the second answer information in the dialog search mode, a third question inputted for the second answer information and third answer information corresponding to the third question.

Still using FIG. 21 as an example, an intelligent question and answer entry in the answer interface is a “continue asking AI” control shown in S2105. The target object clicks S2105 in the list of hotels screened by AI to continue the dialog, and then the network search mode may be switched to the dialog search mode. The target object may directly continue to ask questions based on the second answer information. Then, AI provides an answer (that is, the third answer information) corresponding to the question (that is, the third question) with reference to the personalized corpus (including favorite content, browsed content, and the like) of the target object, content retrieved on the network, and the target language model. In some embodiments, an implementation of the AI question-answering is similar to that in relevant parts of FIG. 14, FIG. 15, and FIG. 16, and details are not described herein again.

In the foregoing implementation, in the result page returned by AI, the object may click “continue asking AI” to switch to dialog question-answering. After the object switches to the AI dialog, AI answers the question with reference to the result of the network search, the personalized corpus of the object, and the target language model.

It is assumed that in a subsequent search, the target object queries another word again, for example, naturally. When AI uses previous search content of the target object as the context for analysis, it is determined that the query of two words (artificial and naturally) belongs to word learning. The two words are correlated, that is, the preset search condition is satisfied. In this search process, the AI suggestion, that is, the first search suggestion information, may be dynamically displayed in the information search interface, and the target object is notified through suggestions that two search operations are related. “Artificial” and “naturally” are antonyms, and the target object may click to view a more detailed current search result once it shows interest.

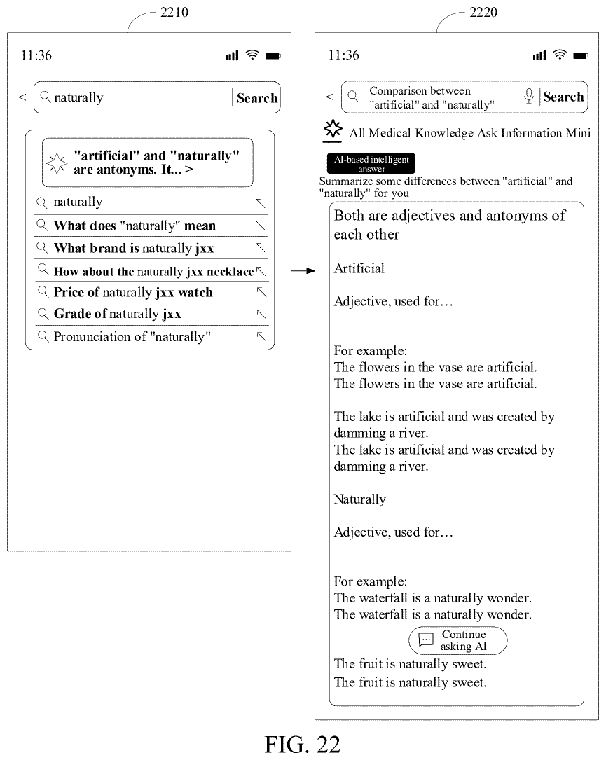

FIG. 22 is a schematic diagram of another first search suggestion information according to an embodiment of this disclosure. First search suggestion information “Artificial and naturally are antonyms. It . . . ” is directly displayed in an information search interface 2210. The target object may click the first search suggestion information to further view a corresponding search result. As shown in an information search interface 2220 on the right side of FIG. 22, some distinctions between “artificial” and “naturally” are summarized.

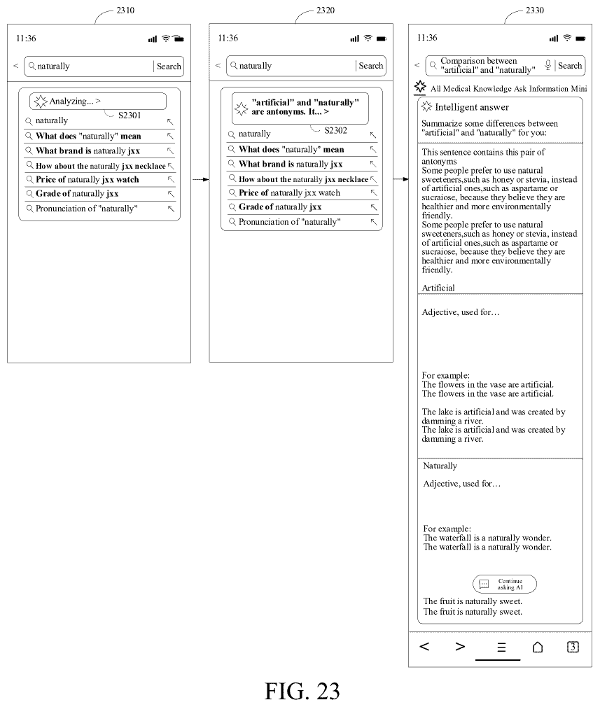

FIG. 23 is a schematic diagram of still another first search suggestion information according to an embodiment of this disclosure. In the search process, a current processing progress, that is, in an analysis stage, is displayed in S2301 in an information search interface 2310. The first search suggestion information is displayed in S2302 in an information search interface 2320, notifying the target object that “artificial” and “naturally” are antonyms, that is, summary information of the current search result of the target object. The target object may click S2302 to enter a search result interface 2330, to display AI search results, that is, some distinctions between “artificial” and “naturally”.

Compared with FIG. 22, one piece of search suggestion information “analyzing . . . ” is provided in the information search interface shown in FIG. 23, which more vividly reflects that the AI suggestion is dynamically displayed along with the analysis process.

In the foregoing implementation, when the object finds no association between search words, the AI screening may actively provide association content between different search words for the object, helping the object better master related knowledge.

In addition, the dynamic AI suggestion provides the object with a quick preview of the AI search result with reference to the context. By browsing the AI suggestion, the object may determine whether content generated by AI with reference to the context needs to be viewed. In addition, the AI suggestion appears in the searching process of the object, and an answer provided by AI may be notified to the object at the moment the object searches. In addition, the form of the AI suggestion does not affect a search word completion suggestion provided when the object browses the network search, so that the object may conveniently switch between the network search and the AI search.

In some embodiments, topic-based intelligent summarization of previously searched content is further supported. When the object searches for content of a plurality of different topics, topic-based summarization may be performed using the target language model, to provide a plurality of AI suggestions and corresponding AI summarized content. An implementation is as follows:
displaying, in response to a summarization operation triggered by the target object, at least one piece of second search suggestion information in the information search interface, each piece of second search suggestion information corresponding to one search topic, and the second search suggestion information being summary information corresponding to the search topic; and at least one search topic being obtained by dividing a plurality of pieces of search information related to the target object.

Based on this, the target object may view summarized content corresponding to any piece of second search suggestion information. In some embodiments, in response to a selection operation for target search suggestion information among the at least one piece of second search suggestion information, the client displays a search result summarization interface corresponding to the target search suggestion information, the search result summarization interface containing summarized content of search results corresponding to search information under a corresponding search topic.

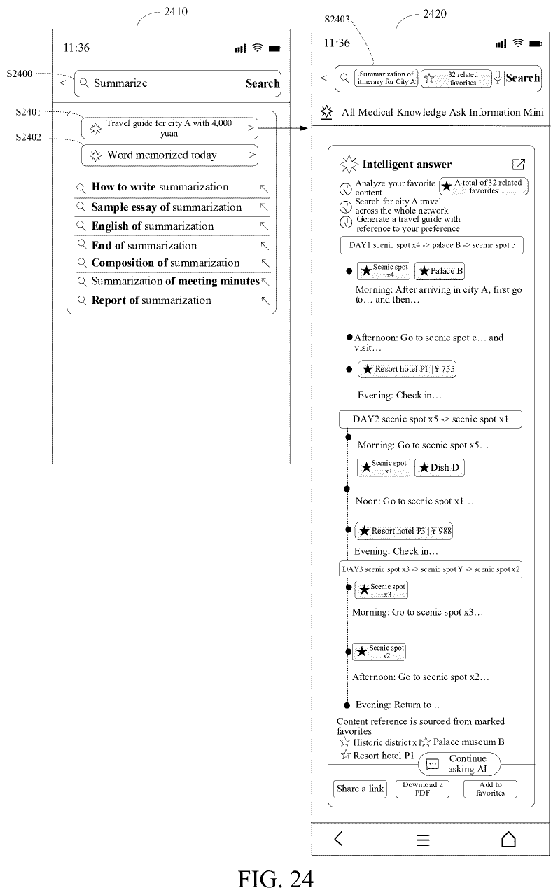

FIG. 24 is a schematic diagram of a content summarization process according to an embodiment of this disclosure. When the target object inputs “summarize” in a search information input area (for example, a search box S2400 in FIG. 24) of an information search interface 2410, AI classifies and summarizes content queried by the target object within a memory range, and displays the content through a plurality of suggestions. As shown in S2401 and S2402, the target object has queried a travel guide for city A and a plurality of words. When the target object inputs “summarize”, AI separately summarizes content of the two topics, and two pieces of displayed second search suggestion information are S2401 “travel guide for city A with 4,000 yuan” and S2402 “words memorized today”. Based on this, the target object may select to click S2401 to view a specific travel guide, or may select to click S2402 to view words memorized today.

After the target object clicks S2401, the travel guide for city A is displayed in an interface 2420, and search information in a search box S2403 in the interface 2420 is updated to “summarization of itineraries in city A”+“32 related favorites”.

In some embodiments, when the search topic is a travel guide, the corresponding summarized content is a travel guide containing an itinerary plan corresponding to at least one travel time period, for example, an itinerary plan of the first day, the second day, and the third day listed in the interface 2420. For example, on the first day, the itinerary includes visiting scenic spot x4→palace B→scenic spot c, scheduled according to time periods such as morning, afternoon, and evening. Specific itinerary plans are listed. Similarly, specific itinerary plans are also provided for the second day and the third day, which may refer to FIG. 16. Details are not described herein again.

In addition, the summarized content is further tagged with favorite content referred to by the travel guide, for example, “Content reference is sourced from marked favorites: historic district x1, palace museum B, and resort hotel P1” marked at the bottom of the interface 2420.

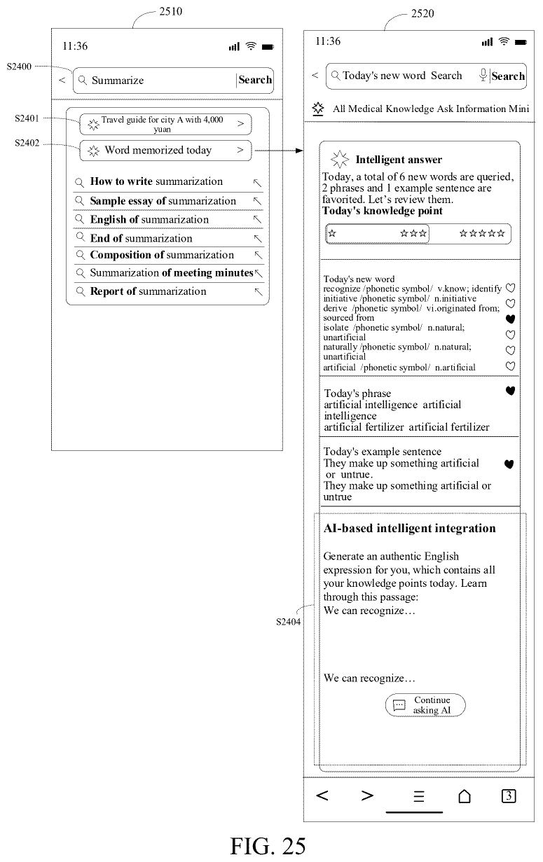

FIG. 25 is a schematic diagram of another content summarization process according to an embodiment of this disclosure. When the target object inputs “summarize” in a search information input area (for example, a search box S2400 in FIG. 25) of an information search interface 2510, AI classifies and summarizes content queried by the target object within a memory range, and displays the content through a plurality of suggestions, as shown in S2401 and S2402 in FIG. 25. If the target object selects to click S2402 to view words learned today, AI summarizes all words queried by the object today, and displays summarized content in an interface 2520.

In some embodiments, if the search topic is concept-based learning, the summarized content includes key concepts divided according to importance, and a knowledge paradigm integrating the key concepts. For example, today's new words, phrases, and example sentences listed in an interface 2520 of FIG. 25 each have importance ranging from one star to three stars. In addition, all the queried words may form an English paragraph, so that the target object can master all today's words by memorizing only one English paragraph. As shown in S2404 in FIG. 25, 6 words queried today are intelligently integrated to generate a knowledge paradigm shown in S2404.

In the foregoing implementation, topic-based intelligent summarization may help the object to classify and summarize different types of contents. In addition, the learning-oriented object may collate periodically searched knowledge in this manner. For an object addressing complex guide problems, when an entire guide task is interrupted in the halfway, a function implemented in this manner may be adopted for summarization at any moment, and a function of continuing the dialog with AI may be adopted to continue the formulation of guide.

The information search method in at least one embodiment of this disclosure is described above from the client. The information search method in at least one embodiment of this disclosure is further described below from a server.

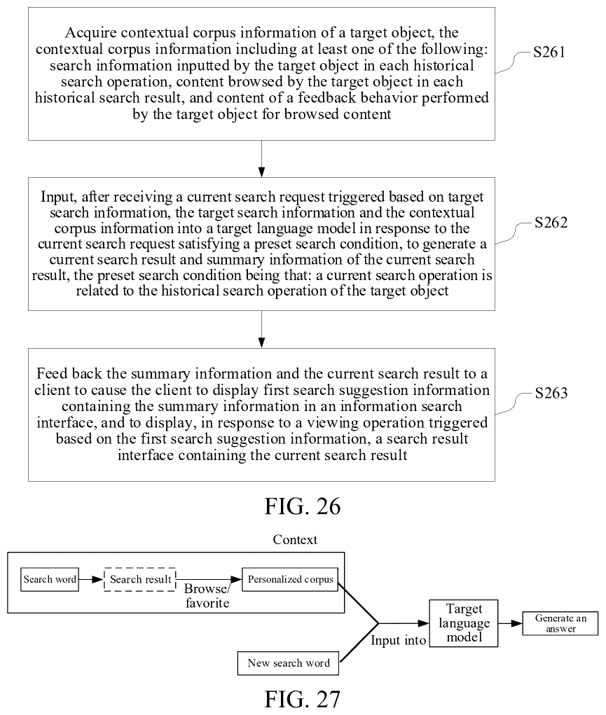

FIG. 26 is an implementation flowchart of another information search method according to an embodiment of this disclosure. The method is performed by an electronic device, for example, the server 120 shown in FIG. 1. In some embodiments, an implementation procedure of the method is shown as S261 to S263.

S261: Acquire contextual corpus information of a target object, the contextual corpus information including at least one of the following: search information inputted by the target object in each historical search operation, content browsed by the target object in each historical search result, and content of a feedback behavior performed by the target object for browsed content.

In some examples, contextual corpus information associated with a target object (e.g., a user) is obtained. In some examples, the contextual corpus information includes historical search information of one or more historical search operations, browsed content from each historical search result of the one or more historical search operations, or records of feedback behaviors performed in association with the browsed content.

In at least one embodiment of this disclosure, data may be continuously collected according to each search process of the target object to update the contextual corpus information of the target object. The contextual corpus information of the target object may be in the form of a database, that is, a personalized corpus. Construction of the personalized corpus is roughly divided into three processes: A, data collection, B, data preprocessing, and C, corpus construction.

The foregoing three processes are briefly described below.

### A. Data Collection.

The contextual corpus information is classified into three types: search information of each search operation of the target object, content browsed by the target object in each search result, and content of a feedback behavior performed by the target object.

The content browsed by the target object in each search result and the content of the feedback behavior performed by the target object may be used as favorite content of the target object.

A process of collecting the favorite content of the target object is briefly described below. When the content browsed by the target object in each search result is collected, each content browsed by the target object may be collected, or screening may be performed with reference to a browsing duration. For example, if the target object browses content of a web page for more than a limited duration, for example, using 5 s as an example, content of the web page is collected.

In addition, using the feedback behavior being a favorite as an example, when the target object favorites an article, the article is collected. When the target object favorites partial content (such as a word, a phrase, an example sentence, or a paragraph) of an article, the partial content is collected.

In at least one embodiment of this disclosure, a manner of favoriting partial content by the target object is not limited. For example, the partial content may be automatically selected after double-clicking. A technical solution of selecting the partial content is implemented based on a text selection engine of a client (an example in which the client is a browser is used subsequently).

Using the partial content being a word or a piece of text as an example, when the target object double-clicks a word or a piece of text, the browser automatically selects an entire word or an entire piece of text according to a selection range of the target object. In addition, the target object may change the selected content by adjusting the selected edge up and down. In some embodiments, an implementation process is as follows, including operation Sa1 to operation Sa7.

Sa1: When the target object double-clicks a word or a piece of text, the browser calculates a start location and an end location of selected text according to a selection range of the target object.

Sa2: The browser determines a range of the selected text according to the start location and the end location.

Sa3: The browser transfers the range of the selected text to the text selection engine.

Sa4: The text selection engine traverses all text nodes in a document tree according to the range of the selected text to find a text node containing the selected text.

Sa5: The text selection engine positions the range of the selected text in the text node and marks a style of the selected text.

Sa6: The browser applies the style of the selected text, for example, a full-paragraph selection style, to the document, so that the target object can see the selected text.

Sa7: When the target object touches a box edge of the full-paragraph selection, an end point of movement of the target object is determined, and the start location and the end location of the text are recalculated according to a movement distance of the target object as a new selection range of the target object.

The foregoing is merely an implementation of selecting partial content of a document according to a selection range of the target object that is listed in at least one embodiment of this disclosure. Other related manners are also applicable to at least one embodiment of this disclosure, and details are not described herein again.

### B. Data Preprocessing

In at least one embodiment of this disclosure, when the contextual corpus information of the target object is constructed by collecting the data, the collected data may further be preprocessed. In some embodiments, an implementation is as follows, including operation Sb1 to operation Sb4.

Sb1: Remove a hypertext markup language (HTML) label: remove the HTML label from web page content using an HTML parser, a regular expression, or other methods, and only retain text content.

Sb2: Sentence segmentation: segment the text content into sentences.

In some embodiments, this operation may be implemented using a sentence tokenizer. A common method involves a rule-based or ML-based model. This is merely an example here, and is not limited herein.

Sb3: Word segmentation: segment a sentence into words or phrases.

In some embodiments, word segmentation may be performed using a word segmentation tool, such as a natural language toolkit (NLTK) or spaCy. This is merely an example here, and is not limited herein.

Sb4: Part-of-speech tagging: tagging a part of speech of each word, such as a noun, a verb, or an adjective.

In some embodiments, this operation may be implemented using a part-of-speech tagger. A common method involves a rule-based or ML-based model. This is merely an example here, and is not limited herein.

### C. Corpus Construction.

After the collected data is preprocessed in the foregoing manner, contextual corpus information corresponding to the target object may be constructed, which may be referred to as a personalized corpus in some embodiments. In some embodiments, an implementation is as follows: constructing preprocessed data into text samples, and storing the text samples in a corpus. Each text sample may be content of a place, a word, a phrase, an example sentence, a paragraph, an article, a web page, or the like.

In some embodiments, these text samples may be stored in a suitable text format, such as txt and csv. This is not limited herein.

S262: Input, after receiving a current search request triggered based on target search information, the target search information and the contextual corpus information into a target language model in response to the current search request satisfying a preset search condition, to generate a current search result and summary information of the current search result, the preset search condition being that: a current search operation is related to the historical search operation of the target object.

In some examples, target search information of a current search operation is received. The target search information and the contextual corpus information are inputted, by processing circuitry of a processing device, into a target language model based on a current search request when the target search information is related to one or more historical search operations. In some examples, a current search result and summary information of the current search result are generated through the target language model.

FIG. 27 is a schematic flowchart of a network search realizing a plurality of rounds of AI searches according to an embodiment of this disclosure. In some embodiments, after inputting a search word (query) in the search engine, the target object may obtain a search result returned by the search engine. Then, the target object browses and favorites the search result, and stores the content as a personalized corpus of the object. Later, the foregoing search word and the personalized corpus, which are used as context, and a new question of the object are inputted into the target language model together, and the target language model provides a new answer with reference to the foregoing content.

In at least one embodiment of this disclosure, with reference to the target language model, a search word of the target object in a previous network search, interface content browsed after the search, and content corresponding to feedback behaviors such as active favoriting and liking of the target object for the interface are used as contextual corpus information to create a personalized corpus, and contextual corpus information generated during each search is provided to the target language model. When the target object asks a question again, the target language model provides summary information of answers of AI in a suggestion interface (that is, the information search interface) according to the acquired content. After the target object clicks the suggestion information of AI, a search answer that is generated with reference to personalized corpus information of the target object and that is provided by the target language model may be seen, thereby providing the target object with the experience that a network search becomes a plurality of rounds of searches.

The summary information is the first search suggestion information. The information is dynamic AI suggestion information. When the target language model determines that a previous search behavior of the target object is associated, the suggestion information dynamically appears during the search input of the target object. Another entry in the suggestion interface is still suggestion information completion for the current search word, and the target object can still perform a network search. That is, the target object may freely select a network search and a target language model search. In some embodiments, a generation process of the information is as follows: Sc1 to Sc5.

Sc1: Understand a context: after the target object inputs a question (referring to target search information), the target language model understands an intention of the target object according to the context with reference to the question of the target object and an acquired personalized corpus (may be referred to as a context in some embodiments), and generates an appropriate answer (that is, a current search result).

In some embodiments, in the process, the problem usually needs to be encoded into a representation form understandable by the model, such as word embedding or vector representation.

Sc2: Generate an answer: the target language model generates an answer according to the context.

In some embodiments, based on a generation algorithm of the model, such as a recurrent neural network (RNN) or a transformer, appropriate suggestion information may be generated according to semantic and syntax rules of the context.

Sc3: Continue to ask questions and generate suggestions: when an answer is generated, the target language model further generates some possible answer suggestion information. This process is usually based on the output of the generation algorithm and the model.

In some embodiments, the generation algorithm may select several most appropriate candidate statements as the suggestion information according to the probability distribution or other rules generated by the model.

Sc4: Sort and screen suggestions: the generated suggestion information needs to be sorted and screened, to provide the target object with the most relevant and useful suggestion.

In some embodiments, the sorting may be implemented based on some indicators, such as confidence of the probability distribution and semantic correlation. The screening may consider some rules or heuristic methods, such as a syntax rule and a common question pattern.

Sc5: According to a change of the search word inputted by the target object, the suggestion information generated by AI also changes correspondingly.

For example, S702 in FIG. 7, FIG. 22, and the like are used as examples, that is, examples of several pieces of first search suggestion information listed in one or more embodiments of this disclosure, which may refer to one or more of the foregoing embodiments. Details are not described herein again.

In at least one embodiment of this disclosure, the current search result generated through the target language model with reference to the target search information and the contextual corpus information is an AI personalized screening result that meets requirements of the object. In some embodiments, the result is generated in the following manner.

For the target object, the target object may perform a plurality of network searches, and the target language model may screen the current search result for the target object through cross-screening of a plurality of previous search words of the target object, and present the current search result in an appropriate form according to a screened content type. In some embodiments, a plurality of search words are compared with each other to provide a result after the comparison.

The following still uses the travel scene and the word query scene listed above as examples, to separately describe a generation process of a corresponding current search result.

### (1) Travel Scene.

In the travel scene, with reference to previous favorite places and the like, AI performs cross-screening by comparing previous search words of the target object, to provide the target object with search results that better meet preferences of the target object. An implementation is as follows. If the target search information is related to a geographic location, the current search result may be generated in the following manner: determining favorite places related to the geographic location in favorite contents of the target object; inputting the favorite places into the target language model, and learning feature information of the favorite places using the target language model; determining at least one recommended place for the target object according to the feature information and a historical behavior of the target object; and collecting, for each recommended place, content related to the recommended place from a network, and extracting information of the recommended place and at least one associated web page from collected content as the current search result.

Still using the travel scenes listed in FIG. 3 to FIG. 16 as examples, when the target object performs a second search for the hotels in city A, the AI finds hotels near the places for the target object by comparing the favorite places of the target object in the personalized corpus as a screening basis. In some embodiments, a process is as follows: Sd1 to Sd4.

Sd1: Input information of the favorite places of the target object into the target language model to cause the target language model to learn features of these places.

Sd2: Recommend hotels: recommend nearby hotels using a collaborative filtering-based or content-based recommendation algorithm.

In some embodiments, the collaborative filtering-based recommendation algorithm refers to recommending an item according to a historical behavior of an object and behaviors of other objects.

For example, if an object A and an object B both like a hotel near a place, the system recommends the hotel to an object C.

In some embodiments, the content-based recommendation algorithm refers to recommending an item according to an attribute of the item and a historical behavior of a target object.

For example, if the target object likes a hotel near a place, the system recommends other similar hotels to the target object.

Sd3: Screen articles on the network: after the hotels are recommended, articles related to the recommended hotels, such as comments, scores, or pictures, are collected from the network using a web crawler technology. Then, these articles are analyzed and processed using the NLP technology, and useful information in the articles is extracted as a notification for the target object. In addition, a network original text connection is acquired, so that the target object may view the original text.

Sd4: Display with reference to a map: display the collected places and the recommended hotels on the map using a map application programming interface (API).

Still using FIG. 8 as an example, S801 is a map module displayed using the map API, including the collected places and the recommended hotels. In addition, as shown in FIGS. 9, S901, S902, and S903 are articles related to the recommended hotels collected from the network, which may refer to one or more of the foregoing embodiments. Details are not described herein again.

### (2) Word Query Scene.

In the word query scene, AI lists similarities and differences between previous search words and the current search word for the target object by comparing the previous search words of the target object. An implementation is as follows. If the target search information is related to concept-based learning, the current search result may be generated in the following manner: inputting a to-be-searched key concept corresponding to the target search information into a trained concept-based recognition model, and determining that an associated key concept of the to-be-searched key concept has been searched by the target object; and determining the to-be-searched key concept, the associated key concept, and an explanation of the to-be-searched key concept as the current search result.

The foregoing manner is briefly described below using an example in which a to-be-searched key concept is a word, and a concept-based recognition model is an antonym recognition model. In some embodiments, a process is as follows: Se1 to Se6.

Se1: Data collection: first, corpus data containing a large quantity of words and synonyms of the words needs to be collected. The data may be sourced from an antonym dictionary, a synonym dictionary, a corpus, or a manually tagged data set.

Se2: Model construction: train an antonym recognition model using the collected data.

In some embodiments, an ML algorithm such as a support vector machine (SVM) or a deep learning model such as an RNN or a transformer model may be used. This is not limited herein.

Se3: Feature extraction: each word needs to be converted into a feature representation that may be processed by the ML algorithm.

In some embodiments, the word may be converted into a vector representation using a word vector model (such as Word2Vec or GloVe) or another feature engineering method. This is not limited herein.

Se4: Model training: train the antonym recognition model using the collected data and the extracted features. A supervised learning method may be adopted to use a word and a label indicating whether the word is an antonym as training samples.

Se5: Model evaluation and optimization: evaluate a trained antonym recognition model using a test data set, and optimize and adjust the antonym recognition model according to an evaluation result.

Se6: Model application: apply the trained antonym recognition model to an actual scene.

In some embodiments, when the target object queries a word, the antonym recognition model may determine whether an antonym of the word has been inputted by the target object. If the antonym has been inputted, a set of words and related explanations thereof are together returned.

Still using FIG. 22 as an example, “artificial” queried by the target object and “naturally” previously queried by the target object are synonyms, and corresponding related explanations are shown in the right interface of FIG. 22, which may refer to one or more of the foregoing embodiments. Details are not described herein again.

In some embodiments, the search result interface further includes supplemental notification information matching the current search result. In at least one embodiment of this disclosure, the supplemental notification information is notification information related to date information and/or place information in the target search information. The supplemental notification information may be determined in the following manner and then fed back to a client, so that the client displays the supplemental notification information to the target object. A specific process is as follows: extracting the date information and the place information; generating, based on the date information and the place information, notification information corresponding to each notification template according to preset notification templates; sorting generated notification information according to a preset weight, and using notification information whose sorting result falls within a specified order range as the supplemental notification information; and feeding back the supplemental notification information to the client for display in the search result interface.

In some embodiments, the server may store two types of notification templates: a template containing the date information and a template without the date information.

The template containing the date information includes, but is not limited to, (a) a weather template, (b) a major festival template, (c) a traffic restriction template, and (d) a travel clothing template. The template without the date includes, but is not limited to, (e) a restriction information template of a site (for example, a visit restriction information template of a scenic spot) and (f) a welfare information template of a merchant.

Content contained in each notification template is as follows.

(a) The weather template contains local temperature and weather conditions during the date.

(b) The major festival template contains the date and local festival activity information within a date range.

(c) The traffic restriction template contains the date and local traffic restriction information within a date range.

(d) The travel clothing template contains the data and travel clothing suggestion information within a date range provided with reference to the temperature.

(e) The restriction information template of a site contains entry restriction information of a related place.

(f) The welfare information template of a merchant contains welfare information of a related place.

In at least one embodiment of this disclosure, when viewing the AI-based intelligent screening result, the target object may extract date information and place information in this related search process of the target object, and input the date information and the place information to a search engine to sequentially acquire (a) to (f) template information. Further, the acquired template information is sorted according to weights of (a) to (f). Using top two of the ranking being a specified order range as an example, the top two templates may be presented in a final search result interface. When there are less than two templates, one template is presented. If there is less than one template, no template is presented.

The preset weight corresponding to the notification template may be flexibly set according to an actual requirement. For example, weights of (a) to (f) may be set to sequentially decrease, sequentially increase, or the like. This is not limited herein.

In some embodiments, the supplemental notification information is shown in S1001 and S1002 in FIG. 10, S1101 in FIG. 11, S1201 in FIG. 12, and S1301 in FIG. 13, which may refer to one or more of the foregoing embodiments. Details are not described herein again.

In the foregoing implementation, the display of the supplemental notification information helps the object learn more content at a time, thereby reducing search paths of the object, and further improving the efficiency of the current information search of the object.

S263: Feed back the summary information and the current search result to a client to cause the client to display first search suggestion information containing the summary information in an information search interface, and to display, in response to a viewing operation triggered based on the first search suggestion information, a search result interface containing the current search result.

In some examples, the summary information and the current search result are outputted, by the processing circuitry of the processing device, to a terminal for display. In some examples, the terminal is configured to display first search suggestion information indicating the summary information in an information search interface, and to display a search result interface including the current search result.

FIG. 7, FIG. 8, FIG. 22, FIG. 23, and the like are schematic diagrams of several pieces of first search suggestion information and corresponding search result interfaces according to one or more embodiments of this disclosure. Various implementations may refer to one or more of the foregoing embodiments, and details are not further described.

In addition, the information search method in at least one embodiment of this disclosure further supports switching the AI screening result to a dialog search mode. If the search result interface or the answer interface is set to further includes an intelligent question and answer entry, the target object may perform mode switching based on the intelligent question and answer entry.

In at least one embodiment of this disclosure, answer information generated in the AI dialog may correspond to a search result with reference to the personalized corpus. After the target object switches to the AI dialog, AI answers the question with reference to the result of the network search, the personalized corpus of the target object, and the target language model. In some embodiments, a process is as follows: Se1 to Se3.

Se1: Establish an index for the personalized corpus of the target object.

In at least one embodiment of this disclosure, after the personalized corpus is established and data cleaning and preprocessing are performed on the personalized corpus, an index needs to be established. The index is a data structure, and is configured to rapidly retrieve text data.

In some embodiments, an index may be established for the text data in the personalized corpus using an open-source search engine library, such as Elasticsearch and Solr.

Se2: Develop a search plug-in for retrieving the text data in the personalized corpus.

In some embodiments, the plug-in may use an API of a search engine library to retrieve the text data in the personalized corpus through a keyword, and integrate a search result into an answer.

Se3: Integrate into the target language model: integrate the search plug-in into the target language model to invoke the plug-in when answering a question, and present content of the personalized corpus.

In at least one embodiment of this disclosure, the personalized corpus is combined in an AI dialog process, and the content of the target language model may be generated more flexibly using the technical solution of the plug-in. In addition, this disclosure further supports that the object may select to enable or disable the plug-in to affect the generated content.

In some embodiments, this disclosure further supports the object to perform a multimodal AI search on any content. After browsing any scene in a result page, the object may long-press to select text or a picture, and then ask questions about the selected content. The target language model answers with reference to the selected content and the question of the object. An implementation is as follows: determining, after the target object performs content selection for the current search result, selected target content according to a selection range of the target object; converting, after detecting voice of a question inputted by the target object for the target content, the voice into text; performing semantic analysis and keyword extraction on the text to obtain a text recognition result; and inputting the text recognition result and the target content into the target language model to obtain answer information generated by the target language model for the question, and feeding back the answer information to the client to cause the client to display an answer interface, the answer interface including the target content, the question, and the answer information.

Using the client being a browser as an example, the process includes operation Sf1 to operation Sf6.

Sf1: When the target object long-presses a word or a piece of text, the browser calculates a start location and an end location of selected text according to a selection range of the target object to position and select the piece of text.

Sf2: Detect a voice input event: the voice input event is detected in the browser, and the target object can respond in time when starting voice input.

Sf3: Invoke a voice recognition API: invoke, when the target object starts voice input, the voice recognition API provided by an operating system of a mobile phone to convert the voice input of the target object into text.

Sf4: Process a recognition result: the voice recognition API returns recognized text and processes the text, for example, performs semantic analysis and keyword extraction, to match a search result more accurately.

Sf5: Provide the text acquired in operation Sf1 and the question acquired in operation Sf4 to the target language model together.

Sf6: Provide an answer according to the input content using the target language model.

As shown in FIG. 20 and FIG. 21, details may refer to one or more of the foregoing embodiments and are not described herein again.

In the foregoing implementation, the multimodal AI search of the object at any location is supported, so that a path of object operation may be shortened, and experience of searching anywhere may be realized.

In at least one embodiment of this disclosure, in any search process, the target object may further be interested in partial content of a corresponding search result. AI-based intelligent favoriting may be performed on such content.

When the target object favorites a paragraph of text, content such as a place and a name in this part of content may be highlighted and specially displayed. For example, FIG. 6, FIG. 18, FIG. 19, and the like are several related examples of AI-based intelligent favoriting listed in one or more embodiments of this disclosure. Various implementations may be based on one or more of the foregoing embodiments, and details thereof are not further described.

In some embodiments, an implementation solution of the AI-based intelligent favoriting is briefly described below.

When the favorite content of the target object is a paragraph, content in the paragraph may be labeled from the following several dimensions:

(1) a place label, (2) an event label, (3) an item label, and (4) a time label.

Methods for labeling the foregoing four dimensions are separately described below.

(1) A method for labeling the place label is as follows.

In at least one embodiment of this disclosure, places may be classified into the following types: A restaurant, B scenic spot, C shop place, D hotel place, and E another place. In some embodiments, these types of places in the content need to be labeled, and a quantity of occurrences of a recurring place needs to be marked.

In some embodiments, there are multiple methods for labeling the foregoing several types of places and marking the quantity of occurrences. Two methods are simply listed below.

Method 1: Train a new place model. In some embodiments, an implementation solution of the method includes operation Sg1 to operation Sg6.

Sg1: Data preparation: collect guide data of travel places, and collate the guide data into a text format.

In some embodiments, the guide data may be extracted from a travel website using a crawler tool, or may be acquired from other data sources.

Sg2: Data cleaning: clean collected guide data to remove useless information and noise data.

In some embodiments, guide text may be processed using the NLP technology through word segmentation, part-of-speech tagging, named entity recognition (NER), or the like. In at least one embodiment of this disclosure, preprocessing such as word segmentation and part-of-speech tagging is performed on the guide text to better understand a structure and semantics of the guide text. The NER may be implemented using an NER model, for example, an ML-based conditional random field (CRF) or a deep learning-based RNN model, to perform entity recognition on an article. These models may tag named entities such as places, person names, and institutions in the guide text.

Sg3: Place type classification: classify places in the guide text using an ML algorithm or a deep learning algorithm, such as Naive Bayes, a SVM, or a convolutional neural network. The places are classified into A restaurant, B scenic spot, C shop place, D hotel place, and E another place, and a classification model is trained for each type.

Sg4: Model evaluation and tuning: evaluate a trained classification model using a test set. Evaluation indicators may include accuracy, a recall rate, an F1 value, and the like. Further, the classification model is tuned according to an evaluation result, for example, a model parameter is adjusted, or a training data volume is increased.

Sg5: Marking of places in favorite content of target object: the guide text is inputted into a tuned classification model, and the classification model outputs information of a label of a place type and a quantity of occurrences of a recurring scenic spot.

Sg6: Favorite result presentation and storage: visually present an output result.

In some embodiments, a recognized place noun is compared with the original text to determine a location at which the place noun appears in the original text, and a special form is presented at the location, as shown in S502 in FIG. 5.

In addition, in an animation presentation of a favoriting process of the target object, different types of places may be tagged with different colors. A corresponding label may be further displayed for each type of place in the favorites of the target object, and a quantity of occurrences is tagged beside the recurring scenic spot.

Method 2: Information comparison. In some embodiments, an implementation solution of the method includes operation Sh1 to operation Sh4.

Sh1: Place word extraction: for favorite text of the target object, the guide text is processed using an NLP technology, including word segmentation, part-of-speech tagging, NER, and the like, to extract place words in the text.

In some embodiments, an open-source tool may be used, such as jieba word segmentation and Stanford named entity recognition (StanfordNER).

Sh2: Place classification recognition: determine a place type of each place word from A restaurant, B scenic spot, C shop place, D hotel place, and E another place through network retrieval or comparison in existing data.

In some embodiments, a search engine may be adopted to search for a place name, and a type of the place is determined according to information in the search result. Existing place classification data, such as map software, may further be used for comparison.

Sh3: Recurring scenic spot recognition: for the same type of places, a recurring scenic spot in the guide text is determined using a technology such as similarity calculation.

In some embodiments, similarity calculation, such as cosine similarity or Jaccard similarity, may be performed on the place words to determine whether the place words are similar. If they are similar, they are considered to be a recurring scenic spot, and a quantity of occurrences of the recurring scenic spot is recorded.

Sh4: Favorite result presentation and storage: visually present an output result.

As above, a recognized place noun is compared with the original text to determine a location at which the place noun appears in the original text, and a special form is presented at the location, as shown in S502 in FIG. 5.

In addition, in an animation presentation of a favoriting process of the target object, different types of places may be tagged with different colors. A corresponding label may be further displayed for each type of place in the favorites of the target object, and a quantity of occurrences is tagged beside the recurring scenic spot.

In summary, according to the method for re-training a model in the foregoing method 1, higher accuracy and customization capabilities may be obtained. In the foregoing solution 2, a function may be quickly realized using the information comparison method.

(2) A method for labeling the event label is as follows.

In at least one embodiment of this disclosure, the definition of events includes two types: an event on a specific date (for example, a public event such as a historical anniversary or a festival celebration), and an event on a non-specific date (for example, a daily float parade).

In some embodiments, the method for labeling the event is similar to the method for labeling the place. A new event model is trained, and major events appearing in the favorite content of the target object may be marked using the model. An information comparison method may further be adopted to compare network information, so as to recognize events in the content.

(3) A method for labeling the item label is as follows.

In at least one embodiment of this disclosure, the definition of items includes, but is not limited to, a special commodity, a special food, a special toy, and the like.

In some embodiments, the method for labeling the item is also similar to the method for labeling the place. A new item model is trained, and items appearing in the favorite content of the target object may be marked using the model. An information comparison method may further be adopted to compare network information, so as to recognize objects in the content.

(4) A method for labeling the time label is as follows.

In at least one embodiment of this disclosure, time information, including but not limited to a time point, a date, a season, a year, and the like, in the text may be recognized using an LLM-based time information recognition model. Further, the model is adopted to determine whether there is a scenic spot, an event, or an item related to the time point in the text. A corresponding time label is added to the related scenic spot, event, or item.

An example in which the favorite content of the target object is a paragraph is used in the foregoing. When the favorite content of the target object is a word (or a phrase, an example sentence, or the like), the word (or the phrase, the example sentence, or the like) may be labeled in the following manner. If the target object selects the word (or the phrase), the word (or the phrase) may be compared with a database to acquire a difficulty score of the word (or the phrase). Further, the score of the word (or phrase) is displayed in a related interface (such as a search result interface or a favorite interface) in the form of a label.

If the target object favorites a sentence, words in the sentence may be scored, and an average score of the scores is calculated as a score of the sentence. Further, the words, the sentence, and the corresponding difficulty scores are stored together, and the score of the sentence is displayed in a related interface (such as a search result interface or a favorite interface) in the form of a label.

The above are merely simple examples in which the favorite content of the target object is a paragraph, a word, a phrase, a sentence, or the like. In some embodiments, the content may be in another form, and the corresponding analysis methods are similar. Details are not described herein again.

In some embodiments, topic-based intelligent summarization of previously searched content is further supported. When the object searches for content of a plurality of different topics, the target language model may perform topic-based summarization to provide a plurality of AI suggestions and corresponding AI results. An implementation is as follows: separately determining, after receiving a summarization request triggered by the target object, search topics corresponding to a plurality of pieces of search information related to the target object; summarizing search results of the search topics through the target language model to obtain summarized content corresponding to the search topics; scoring and sorting the summarized content, and filtering out summarized content whose score is less than a preset score threshold; and generating second search suggestion information corresponding to remaining summarized content, and feeding back the second search suggestion information to the client, the second search suggestion information being summary information corresponding to a corresponding search topic, to cause the client to display, in response to a summarization operation, at least one piece of second search suggestion information in the information search interface, and to display, in response to a selection operation for target search suggestion information among the at least one piece of second search suggestion information, a search result summarization interface corresponding to the target search suggestion information, the search result summarization interface containing summarized content under a search topic corresponding to the target search suggestion information.

In some embodiments, a technical solution is as follows: Sn1 to Sn5.

Sn1: Determine different topics.

In some embodiments, contents of different topics in the search word inputted by the target object may be determined through the following method.

A: Keyword matching: the target language model may extract a keyword in a current problem (that is, target search information) and match the keyword with a keyword in context (that is, contextual corpus information). If there is a keyword related to the current problem in the contextual corpus information, this part of context may be useful.

B: Semantic similarity: the target language model may calculate the semantic similarity between the current question and the context. By comparing a semantic representation of the problem with a semantic representation of the context, contexts with stronger semantic relevance to the current question may be determined, thereby determining the usefulness of the contexts.

C: Topic modeling: the target language model may recognize the topic in the context using a topic modeling technology, such as latent Dirichlet allocation (LDA) or a pre-trained language representation model (bidirectional encoder representation from transformers, (BERT)). If the topic in the context is highly related to the topic of the current problem, this part of context may be useful.

Sn2: Label the content according to topics, and assign a unified label to content belonging to the same search topic.

Sn3: After the target object inputs “summarize”, the target language model summarizes according to contents of different topics of the target object, and summarizes the contents of different topics using a search topic as a unit.

Sn4: Scoring and sorting: score and sort generated summarized content, and filter out content with a relatively low score.

The following are some common scoring factors.

A: Keyword matching: a search engine may check whether a keyword on a web page matches a search query of the target object. If the keyword occurs frequently in the title, the main text, and other labels, the web page may have a higher score.

B: Content quality: the search engine may evaluate the content quality of the web page, including accuracy, completeness, and correlation of information. A web page with high content quality usually has a higher score.

C: External link: the search engine may consider the quantity and quality of links of other websites to the web page. If another trusted website is linked to the web page, the web page may have a higher score.

D: Target object experience: the search engine may analyze an interaction situation between the target object and a search result, for example, a click-through rate, a dwell time, and a rebound rate. If the target object is interested in and interacts with a search result, the web page may have a higher score.

E: Web page structure and mark: the search engine may analyze the structure and mark of a web page, such as a title label, a paragraph label, and an image label. A good web page structure and mark may improve understanding of the search engine on web page content, thereby affecting the score.

The foregoing listed several manners for scoring and sorting the generated summarized content are merely simple examples. In addition, other scoring manners are also applicable to at least one embodiment of this disclosure, and details are not described herein again.

Sn5: Generate a corresponding AI suggestion (that is, the second search suggestion information in this specification) for each summarized content. Content of the AI suggestion is a summary of the corresponding content, and the summary contains keywords of the topic.

As shown in FIG. 24 and FIG. 25, details may refer to one or more of the foregoing embodiments and are not described herein again.

In addition, in this embodiment of this disclosure, the foregoing favorite content may be configured to generate the summarized content. In some embodiments, the favorite content of the target object may be classified according to a preset dimension, and the classification label corresponding to each favorite content is tagged (details may refer to one or more of the foregoing embodiments, for example, the place label, the event label, the item label, or the time label is marked). Further, when search results of different search topics are summarized using the search topic as a unit through the target language model to obtain summarized content corresponding to each search topic, target favorite content related to the target search information in the favorite content may be retrieved according to the classification label. Further, using the search topic as a unit, the search results of different search topics are summarized based on the target favorite content through the target language model to obtain the summarized content corresponding to each search topic.

The travel scene and the word query scene are used as examples below for brief descriptions.

### (1) Travel Scene.

In at least one embodiment of this disclosure, if the target search information is related to a travel guide, corresponding summarized content, such as the travel guide, may be generated using the target language model by invoking a place label. An implementation is as follows.

First, the favorite content of the target object is analyzed, and favorite places related to a travel destination are extracted from the favorite content of the target object. Further, network information related to the favorite places is collected according to the extracted favorite places. Recommended places are generated with reference to the target language model and the network information. Finally, after the favorite places and the recommended places form a place library, a corresponding travel guide is generated according to the places in the place library.

In some embodiments, a solution for invoking the place label involved in the foregoing implementation is as follows: Si1 to Si6.

Si1: Favorites content management: in the favorites of the target object, tag each place with five place labels: A restaurant, B scenic spot, C shop place, D hotel place, and E another place, and tag a quantity of occurrences of a recurring scenic spot.

Si2: Extraction of favorite content of target object: when the target object requests to formulate a guide for a specific scenic spot, the target language model (such as chat generative pre-trained transformer (chatGPT)) needs to analyze the favorite content of the target object to extract favorite places of the target object that are related to the destination.

In some embodiments, the preference of the target object may be analyzed and extracted using an ML algorithm or a rule engine.

Si3: Data collection: collect related information from the network according to the extracted related places.

For A restaurant, information such as a place, an evaluation score, an average cost per person, signature dishes, and pictures of the restaurant is collected.

For B scenic spot, information such as a place, an evaluation score, a ticket, opening hours, and pictures of the scenic spot is collected.

For C shop information, information such as a place, an evaluation score, opening hours, an average cost per person, and pictures is collected.

For D hotel, information such as a place, a room type, a price corresponding to the room type, room availability status, and pictures is collected.

For E another type, information such as a place, an evaluation score, and pictures is collected.

Si4: Exploratory recommendation: generate, with reference to the target language model and the network information, more places according to places that the target object is interested in.

In some embodiments, types generated in this operation include, but are not limited to, the following two types.

Manner 1: collect other travel places within a 1 km range according to location information of the favorite place.

Manner 2: collect scenic spots of a related type using a recommendation algorithm according to a type of the favorite place.

Further descriptions are as follows.

A: Collect scenic spots, shops, and hotels within 1 km around a restaurant according to information of A restaurant in the preference of the target object, and preferentially sort the favorite places of the target object. Then, other restaurants similar to A restaurant are searched for according to the recommendation algorithm.

B: Collect other nearby places including restaurants, shops, hotels, and scenic spots according to address information of B scenic spot, and preferentially sort favorite scenic spots of the target object. Then, according to information of B scenic spot in the preference of the target object, some scenic spot recommendations that the target object may be interested in but are not aware of are generated using the recommendation algorithm or other technologies. For example, if the target object favorites a natural scenery scenic spot, the recommendation algorithm may recommend some related natural reserves, wildlife parks, or the like.

C: Collect scenic spots, restaurants, and hotels within 1 km around the shop according to information of C shop in the preference of the target object, and preferentially sort the favorite places of the target object. Then, other shops similar to C shop are searched for according to the recommendation algorithm.

D: Collect scenic spots, restaurants, and shops within 1 km around the hotel according to the place of D hotel in the preference of the target object, and preferentially sort the favorite places of the target object. Then, other hotels similar to D hotel are searched for according to the recommendation algorithm.

E: Collect scenic spots, restaurants, shops, and hotels within 1 km around the place according to the place of E another type in the preference of the target object, and preferentially sort the favorite places of the target object.

Si5: Establish a place library and sort the places therein: the target language model uses 5 types of favorite places of the target object, the places generated through exploratory recommendation, and guide places searched on the network as the place library, and generates a travel guide according to the places in the place library.

Priorities of three types of sources are as follows: favorite places of the target object>places generated through exploratory recommendation>network recommended places. In the three types of sources, priorities of places of the five place types are separately sorted, and a larger quantity of occurrences indicates a higher priority.

In some embodiments, for the five place types listed above, places of each place type are sorted according to corresponding source priorities. For example, three places of category A: a place A1, a place A2, and a place A3, are sourced from the favorite places of the target object, the places generated through exploratory recommendation, and the network recommended places, respectively, and a sorting result is: place A1>place A2>place A3. In some embodiments, places of the same source may be randomly sorted, sorted according to occurrences, sorted according to place names, or the like. This is not limited herein.

Si6: Itinerary formulation: select 5 types of places from the place library to generate a travel guide.

In some embodiments, the travel guide includes an itinerary plan corresponding to at least one travel time period. When a corresponding travel guide is generated according to the places in the place library, at least one travel time period may be obtained through division with reference to a travel time set by the target object. Further, for each travel time period, a corresponding quantity of places of corresponding types are selected according to source priorities corresponding to the places in the place library to generate the itinerary plan corresponding to the travel time period.

For example, in the generated guide, the daily itinerary includes: 1 to 2 places of B scenic spot, 3 places of A restaurant, 0 to 2 places of shops, 1 place of D hotel, and 0 to 2 places of E another type. A corresponding quantity of places of corresponding types are selected according to priority orders in the place library, and a use solution of an event label of the travel guide is generated according to a specific quantity of days required by the target object with reference to algorithms such as route calculation of the target language model.

FIG. 16, S2403 in FIG. 24, and the like are still used as examples, that is, examples of several travel guides listed in one or more embodiments of this disclosure, which may refer to one or more of the foregoing embodiments. Details are not described herein again.

In at least one embodiment of this disclosure, if the travel guide requirement does not contain specific time information, event suggestion information for the target object beyond the itinerary plan may be generated based on a non-fixed-date event related to the travel destination in the favorite content. If the travel guide requirement contains specific time information, and the time information coincides with a time of a fixed-date event related to the travel destination in the favorite content, the fixed-date event may be added to a corresponding itinerary plan.

In some embodiments, a solution for invoking the event label involved in the foregoing implementation is as follows: Sj1 to Sj4.

Sj1: The target object searches for a non-fixed-date event in the favorites when the guide requirement does not contain specific time information.

Sj2: Provide, beyond an accommodation-inclusive itinerary, event suggestions for the target object in the form of tips using the non-fixed-date event related to the destination.

Sj3: Search for a fixed-date event in the favorites when the requirement of the target object contains the specific time information.

Sj4: Determine whether a travel date of the target object coincides with the fixed-date event, and arrange the event in the itinerary plan when the two coincide.

In at least one embodiment of this disclosure, an item label of a related place in the favorite content may further be searched for according to a travel guide requirement proposed by the target object. Further, an item suggestion for the target object beyond the itinerary is generated based on the item label. In addition, a shop in which an item may be purchased is determined through a network search, and a target shop place, among the searched shops, within a preset distance range from a formed route is added to a corresponding itinerary plan.

In some embodiments, a use solution of the item label involved in the foregoing implementation is as follows: Sk1 to Sk3.

Sk1: The target object proposes a guide requirement and searches for item labels of related places in the favorites.

Sk2: Provide, beyond an accommodation-inclusive itinerary, a suggestion of a related item for the target object in the form of tips, for example, a purchasable specialty.

Sk3: Search, through a network, for a shop in which the item may be purchased, search for a shop within 1 km of the route of the itinerary, and plan a shop place in the itinerary plan.

In at least one embodiment of this disclosure, if the travel guide requirement proposed by the target object contains the specific time information, events, scenic spots, and items related to the time label in the favorite content are searched. The information of the events, scenic spots, and items that meet the time label is extracted, inappropriate scenic spots, events, and items in the itinerary are screened out for the target object according to the time information, and related suggestions are generated. In addition, additional information is acquired through a network search, and then provided to the target object.

In some embodiments, a use solution of the time label involved in the foregoing implementation is as follows: Sl1 to Sl4.

Sl1: Search for events, scenic spots, and items related to the time label in the favorites when the requirement of the target object contains specific time information.

Sl2: Extract information of events, scenic spots, and items that meet the time label, and screen out inappropriate scenic spots, events, and items in the itinerary for the target object according to the time information.

Sl3: Provide, beyond the itinerary, the target object with an additional suggestion in the form of tips. For example, it is unsuitable to go to place H in city X during March.

Sl4: Additional information, such as weather corresponding to a date, may be further acquired through a network search, and then provided to the target object in the form of tips.

### (2) Word Query Scene.

In some embodiments, a summarization process is as follows: Sm1 to Sm5.

Sm1: Favorite content management: establish a favorite content management system in an application (APP), and label each content according to a difficulty label generated during favoriting.

Sm2: Retrieval of favorite content: retrieve the favorite content of the target object from stored data.

Sm3: AI summarizes historical content of the target object: AI acquires, according to a browsing record, all words, phrases, and sentences that the target object queries today, and scores difficulty of each historical sentence according to a database.

Sm4: Tag historical content and the favorite content in two dimensions: a content type dimension: a word, a phrase, and a sentence; and a content difficulty dimension: one star to five stars.

Sm5: The target object may screen summarized key concepts through the two dimensions.

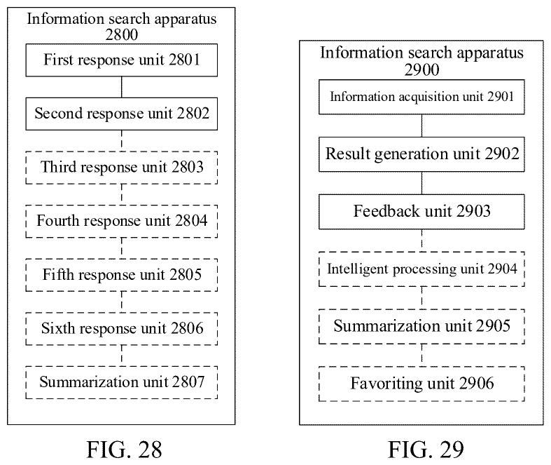

Based on the same concept, one or more embodiments of this disclosure further provide an information search apparatus. FIG. 28 is a schematic structural diagram of an information search apparatus 2800. The apparatus may include:
a first response unit 2801, configured to display, in response to a current search operation triggered by a target object based on target search information satisfying a preset search condition, first search suggestion information in an information search interface, the first search suggestion information including summary information of a current search result; and the preset search condition being that: the current search operation is related to a historical search operation of the target object; and
a second response unit 2802, configured to display, in response to a viewing operation triggered based on the first search suggestion information, a search result interface corresponding to the target search information, the search result interface including the current search result; the current search result being generated based on the target search information and contextual corpus information of the target object; and the contextual corpus information including at least one of the following: search information inputted by the target object in each historical search operation, content browsed by the target object in each historical search result, and content of a feedback behavior performed by the target object for browsed content.

In some embodiments, the search result interface further includes at least one answer operation control. The apparatus further includes: a fourth response unit 2804, configured to perform, in response to a selection operation for a target answer operation control among the at least one answer operation control, an operation corresponding to the target answer operation control for the first answer information, and displaying an execution result of the operation.

In some embodiments, the apparatus further includes: a fifth response unit 2805, configured to identify, in response to a content selection operation triggered based on the search result interface, currently selected target content and intelligent recognition information corresponding to the target content in the search result interface, the intelligent recognition information including at least one of the following: key information contained in the target content, a type of the target content, and importance of the target content.

In some embodiments, the apparatus further includes: a sixth response unit 2806, configured to display a favorite interface in response to a viewing operation for the favorite content of the target object, and tag different classification labels through different tagging styles in the favorite interface, for a recurring classification label, a quantity of recurring times being tagged at a preset location in the favorite interface.

In some embodiments, the apparatus further includes: a summarization unit 2807, configured to display, in response to a summarization operation triggered by the target object, at least one piece of second search suggestion information in the information search interface, each piece of second search suggestion information corresponding to one search topic, and the second search suggestion information being summary information corresponding to the search topic; and at least one search topic being obtained by dividing a plurality of pieces of search information related to the target object; and display, in response to a selection operation for target search suggestion information among the at least one piece of second search suggestion information, a search result summarization interface corresponding to the target search suggestion information, the search result summarization interface containing summarized content of search results corresponding to search information under a search topic corresponding to the target search suggestion information.

Based on the same concept, one or more embodiments of this disclosure further provide another information search apparatus. FIG. 29 is a schematic structural diagram of an information search apparatus 2900. The apparatus may include:
an information acquisition unit 2901, configured to acquire contextual corpus information of a target object, the contextual corpus information including at least one of the following: search information inputted by the target object in each historical search operation, content browsed by the target object in each historical search result, and content of a feedback behavior performed by the target object for browsed content;
a result generation unit 2902, configured to input, after receiving a current search request triggered based on target search information, the target search information and the contextual corpus information into a target language model in response to the current search request satisfying a preset search condition, to generate a current search result and summary information of the current search result, the preset search condition being that: a current search operation is related to the historical search operation of the target object; and
a feedback unit 2903, configured to feed back the summary information and the current search result to a client to cause the client to display first search suggestion information containing the summary information in an information search interface, and to display, in response to a viewing operation triggered based on the first search suggestion information, a search result interface containing the current search result.

In some embodiments, the apparatus further includes: an intelligent processing unit 2904, configured to determine, after the target object performs content selection for the current search result, selected target content according to a selection range of the target object; convert, after detecting voice of a question inputted by the target object for the target content, the voice into text; perform semantic analysis and keyword extraction on the text to obtain a text recognition result; and input the text recognition result and the target content into the target language model to obtain answer information generated by the target language model for the question, and feed back the answer information to the client to cause the client to display an answer interface, the answer interface including the target content, the question, and the answer information.

In some embodiments, the apparatus further includes: a summarization unit 2905, configured to separately determine, after receiving a summarization request triggered by the target object, search topics corresponding to a plurality of pieces of search information related to the target object; summarize search results of the search topics through the target language model to obtain summarized content corresponding to the search topics; score and sort the summarized content, and filter out summarized content whose score is less than a preset score threshold; and generate second search suggestion information corresponding to remaining summarized content, and feed back the second search suggestion information to the client, the second search suggestion information being summary information corresponding to a corresponding search topic, to cause the client to display, in response to a summarization operation, at least one piece of second search suggestion information in the information search interface, and to display, in response to a selection operation for target search suggestion information among the at least one piece of second search suggestion information, a search result summarization interface corresponding to the target search suggestion information, the search result summarization interface containing summarized content under a search topic corresponding to the target search suggestion information.

In some embodiments, the apparatus further includes: a favoriting unit 2906, configured to classify the favorite contents of the target object according to a preset dimension, and tag a classification label corresponding to each favorite content, the favorite content including at least one of the following: the content browsed by the target object in each historical search result, and content of a positive feedback behavior performed by the target object for the browsed content.

The summarization unit 2905 is configured to retrieve target favorite content related to the target search information in the favorite contents according to the classification label; and summarize, using the search topic as a unit, search results of different search topics based on the target favorite content through the target language model to obtain the summarized content corresponding to the search topics.

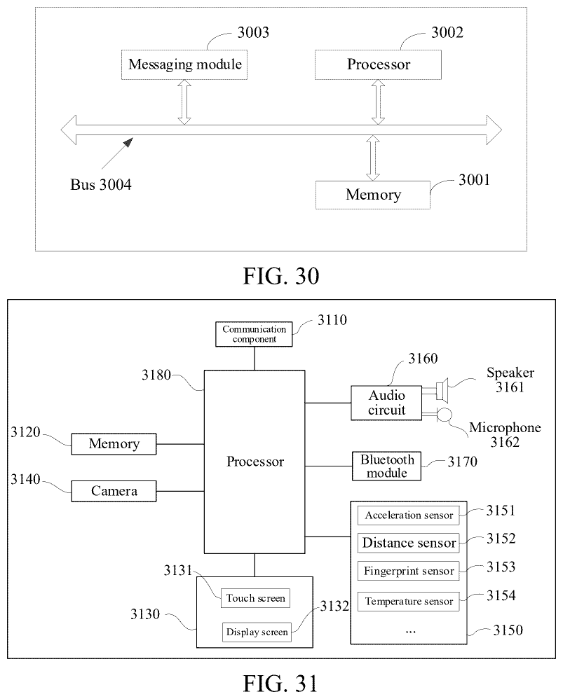

Based on the same concept as one or more of the foregoing method embodiments, various embodiments of this disclosure further provide an electronic device. In an embodiment, the electronic device may be a server, for example, the server 120 shown in FIG. 1. In at least one embodiment, the structure of the electronic device may be shown in FIG. 30, including a memory 3001, a messaging module 3003, and processing circuitry (e.g., one or more processors 3002).

The memory 3001 may include a non-transitory computer-readable storage medium that is configured to store a computer program executed by the processor 3002. In some embodiments, the memory 3001 may include a program storage area and a data storage area. The program storage area may store an operating system, programs required for running instant messaging functions, and the like. The data storage area may store instant messaging information, operating instruction sets, and the like.

The processor 3002 may include one or more central processing units (CPUs), a digital processing unit, or the like. The processor 3002 is configured to implement the foregoing information search method when invoking the computer program stored in the memory 3001.

The messaging module 3003 is configured to communicate with a terminal device and other servers.

A connection among the foregoing memory 3001, messaging module 3003, and processor 3002 is not limited in this disclosure. In at least one embodiment of this disclosure, the memory 3001 and the processor 3002 are connected through a bus 3004 in FIG. 30. The bus 3004 is described through a thick line in FIG. 30. A connection manner among other assemblies is merely for description and is not intended to be limiting. The bus 3004 may be classified as an address bus, a data bus, a control bus, or the like. For ease of description, only one thick line is used for description in FIG. 30, but this does not imply that there is only one bus or one type of bus.

In some embodiments, the memory 3001 includes a non-transitory computer storage medium that has computer-executable instructions stored therein for implementing the information search method in one or more embodiments of this disclosure. The processor 3002 is configured to perform the foregoing information search method, as shown in FIG. 26.

In at least one embodiment, the electronic device may correspond to the terminal device 110 shown in FIG. 1. In at least one embodiment, the electronic device has a structure shown in FIG. 31, and includes: a communication component 3110, a memory 3120 (e.g., including a non-transitory computer readable storage medium), a display unit 3130, a camera 3140, a sensor 3150, an audio circuit 3160, a Bluetooth module 3170, processing circuitry (e.g., a processor 3180), and other assemblies. In some embodiments, the memory 3120 includes a non-transitory computer-readable storage medium configured to store instructions. In some embodiments, the instructions, when executed by processing circuitry (such as the processor 3180), cause the processing circuitry to perform an information search method as described above in this disclosure.

In some possible implementations, various aspects of the information search method provided in this disclosure may be implemented in the form of a program product including a computer program. When the program product runs on an electronic device, the computer program is configured to enable the electronic device to perform the operations in the information search method described in this specification according to various implementations of this disclosure. For example, the electronic device may perform the operations shown in FIG. 2 or FIG. 26.

These computer program instructions may further be loaded onto a computer or another programmable data processing device so that a series of operations are performed on the computer or the another programmable device, thereby generating computer-implemented processing. Therefore, the instructions executed on the computer or the another programmable device provide operations for implementing functions specified in one or more procedures in the flowcharts and/or one or more blocks in the block diagrams.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Although various embodiments of this disclosure have been described, additional changes and modifications may be made to these embodiments. These changes and modifications fall within the scope of this disclosure.

What is claimed is:

1. An information search method, the method comprising:
receiving, by processing circuitry of a processing device, target search information of a current search operation;
displaying first search suggestion information in an information search interface on a display of the processing device when the target search information is related to one or more historical search operations, the first search suggestion information indicating summary information of a current search result based on the target search information and the one or more historical search operations;
obtaining, by the processing circuitry of the processing device, the current search result based on a user operation on the first search suggestion information displayed in the information search interface, the current search result being generated based on the target search information and contextual corpus information that includes:
historical search information of the one or more historical search operations,
browsed content from each historical search result of the one or more historical search operations, or
records of feedback behaviors performed in association with the browsed content; and
displaying the current search result in a search result interface on the display.

2. The method according to claim 1, wherein, when the target search information is related to a geographic location,
the search result interface includes a map element,
the map element is configured to display one or more of:
a favorite place related to the geographic location in stored favorite content,
a recommended place based on a preset recommendation rule and the target search information, or
a travel route between the favorite place and the recommended place, and
the current search result includes information of the recommended place and at least one web page associated with the recommended place.

3. The method according to claim 1, wherein
the search result interface includes a search information input area, and
the method further includes:
updating display in the search information input area from displaying the target search information to displaying the target search information and a quantity of target favorite contents related to the current search operation in stored favorite content; or
updating the display in the search information input area from displaying the target search information to displaying the first search suggestion information.

4. The method according to claim 1, wherein
the search result interface includes supplemental notification information associated with the current search result, and
the supplemental notification information indicates date information or place information related to the target search information.

5. The method according to claim 1, wherein
the search result interface includes a first intelligent question and answer entry, and
the method further includes:
switching the current search operation from an initial network search mode to a dialog search mode based on an operation of the first intelligent question and answer entry; and
displaying a first question inputted for the current search result and first answer information corresponding to the first question based on a questioning operation of the current search result in the dialog search mode.

6. The method according to claim 5, wherein
the search result interface includes at least one answer operation control element; and
the method further includes:
performing an operation corresponding to a selected one of the at least one answer operation control element on the first answer information based on a selection operation; and
displaying an execution result of the operation.

7. The method according to claim 1, further comprising:
identifying currently selected target content and intelligent recognition information corresponding to the target content in the search result interface based on a content selection operation on the search result interface, the intelligent recognition information including:
key information included in the target content,
a type of the target content, or
importance of the target content.

8. The method according to claim 7, further comprising:
displaying an answer interface based on a questioning operation of the target content, the answer interface presenting the target content, a second question inputted for the target content, and second answer information corresponding to the second question.

9. The method according to claim 8, wherein
the answer interface includes a second intelligent question and answer entry, and
the method further includes:
switching the current search operation from an initial network search mode to an dialog search mode based on an operation of the second intelligent question and answer entry; and
displaying a third question inputted for the second answer information and third answer information corresponding to the third question based on a questioning operation of the second answer information in the dialog search mode.

10. The method according to claim 7, further comprising:
favoriting the target content; and
displaying a favorite animation in the search result interface, the favorite animation indicating that the target content flies into a favorite control element in the search result interface.

11. The method according to claim 1, further comprising:
displaying a favorite interface based on a viewing operation for stored favorite content; and
tagging different classification labels with different tagging styles in the favorite interface,
wherein, for a recurring classification label, a quantity of recurring times thereof is indicated at a preset location in the favorite interface.

12. The method according to claim 1, further comprising:
displaying at least one piece of second search suggestion information in the information search interface based on a summarization operation, each piece of second search suggestion information corresponding to one search topic, the second search suggestion information indicating summary information corresponding to the respective search topic, and at least one search topic being obtained by dividing a plurality of pieces of search information; and
displaying a search result summarization interface corresponding to a selected piece of search suggestion information based on a selection operation among the at least one piece of second search suggestion information, the search result summarization interface including summarized content of search results corresponding to search information under a search topic corresponding to the selected piece of search suggestion information.

13. The method according to claim 12, wherein
when the search topic corresponds to a travel guide, the summarized content includes a proposed travel guide including an itinerary plan corresponding to at least one travel time period, and is tagged with favorite content referenced by the proposed travel guide, and
when the search topic corresponds to concept-based learning, the summarized content includes a set of key concepts divided according to importance, and a knowledge paradigm integrating the set of key concepts.

14. An information search method, the method comprising:
obtaining contextual corpus information that includes:
historical search information of one or more historical search operations,
browsed content from each historical search result of the one or more historical search operations, or
records of feedback behaviors performed in association with the browsed content;
receiving target search information of a current search operation;
inputting, by processing circuitry of a processing device, the target search information and the contextual corpus information into a target language model based on a current search request when the target search information is related to one or more historical search operations;
generating a current search result and summary information of the current search result through the target language model; and
outputting, by the processing circuitry of the processing device, the summary information and the current search result to a terminal for display, the terminal being configured to display first search suggestion information indicating the summary information in an information search interface, and to display a search result interface including the current search result.

15. The method according to claim 14, wherein when the target search information is related to a geographic location, the generating the current search result and the summary information comprises:
determining favorite places related to the geographic location in favorite contents associated with a target object;
obtaining feature information of the favorite places through the target language model;
determining at least one recommended place based on the feature information and a historical behavior associated with the target object;
collecting, for each recommended place, content related to the recommended place from a network; and
extracting information of the recommended place and at least one associated web page from collected content as the current search result.

16. The method according to claim 14, further comprising:
extracting date information and place information included in the target search information;
generating a respective piece of notification information indicating the date information and the place information based on each notification template of preset notification templates;
sorting the generated pieces of notification information based on a preset weight;
determining one of the pieces of notification information falling within an order range as supplemental notification information; and
outputting the supplemental notification information to the terminal for display in the search result interface.

17. The method according to claim 14, wherein, when the target search information corresponds to concept-based learning, and the target language model corresponds to a concept-based recognition model, the generating the current search result and the summary information comprises:
inputting a to-be-searched key concept corresponding to the target search information into the target language model;
determining an associated key concept of the to-be-searched key concept that has been searched; and
determining the to-be-searched key concept, the associated key concept, and an explanation of the to-be-searched key concept as the current search result.

18. The method according to claim 14, further comprising:
determining, selected target content within the current search result based on a selection operation from the terminal;
obtaining a question in a text form in association with the target content from the terminal;
performing semantic analysis and keyword extraction on the question to obtain a text recognition result;
inputting the text recognition result and the target content into the target language model to obtain answer information generated by the target language model for the question; and
outputting the answer information to the terminal that is configured to display an answer interface, the answer interface presenting the target content, the question, and the answer information.

19. The method according to claim 14, further comprising:
determining search topics corresponding to a plurality of pieces of search information based on a summarization request from the terminal;
summarizing search results of the search topics through the target language model to obtain summarized content corresponding to the search topics;
scoring and sorting the summarized content, and filtering out a portion of the summarized content with score less than a preset score threshold;
generating one or more pieces of second search suggestion information corresponding to a remaining portion of the summarized content, each piece of the remaining portion of the second search suggestion information including summary information corresponding to a respective search topic; and
outputting the one or more pieces of second search suggestion information to the terminal configured to display at least one piece of the one or more pieces of second search suggestion information in the information search interface based on a summarization operation, and to display a search result summarization interface corresponding to a selected piece of search suggestion information based on a selection operation among the at least one piece of second search suggestion information, the search result summarization interface including summarized content under a search topic corresponding to the selected piece of search suggestion information.

20. An information search apparatus, comprising:
processing circuitry configured to:
receive target search information of a current search operation;
display first search suggestion information in an information search interface on a display of the apparatus when the target search information is related to one or more historical search operations, the first search suggestion information indicating summary information of a current search result based on the target search information and the one or more historical search operations;
obtain the current search result based on a user operation on the first search suggestion information displayed in the information search interface, the current search result being generated based on the target search information and contextual corpus information that includes:
historical search information of the one or more historical search operations,
browsed content from each historical search result of the one or more historical search operations, or
records of feedback behaviors performed in association with the browsed content; and
display the current search result in a search result interface on the display.
